(19) United States
(12) Patent Application Publication
(10) Pub. No.: US 2024/0272339 A1
(43) Pub. Date: Aug. 15, 2024

(54) POLARIZATION GRATINGS HAVING LARGE DIFFRACTION ANGLE, HIGH EFFICIENCY, HIGH DEGREE OF CIRCULAR POLARIZATION OUTPUT

(71) Applicant: Meta Platforms Technologies, LLC, Menlo Park, CA (US)

(72) Inventors: Sawyer MILLER, Bellevue, WA (US); Hsien-Hui CHENG, Woodinville, WA (US); Mengfei WANG, Woodinville, WA (US); Gary D. SHARP, BOULDER, CO (US); Lu LU, Kirkland, WA (US)

(21) Appl. No.: 18/167,742

(22) Filed: Feb. 10, 2023

(51) Int. Cl. G02B 5/18; G02B 5/30; G02B 5/32; G02B 27/28; G03H 1/04

(52) U.S. Cl. CPC G02B 5/1833; G02B 5/3016; G02B 5/32; G02B 27/283; G03H 1/0402; G03H 2001/0439; G03H 2223/13

(57) ABSTRACT

A device includes a Pancharatnam-Berry phase (“PBP”) film stack configured to diffract an input beam as a first polarized beam and a second polarized beam having opposite handednesses. A combined diffraction efficiency of the PBP film stack for the first and second polarized beams is greater than a predetermined value. The device also includes a compensation film stack coupled with the PBP film stack, and configured to respectively convert the first polarized beam and the second polarized beam into a third polarized beam and a fourth polarized beam having the opposite handednesses. The first and second polarized beams include at least one elliptically polarized beam, and the third and fourth polarized beams are two circularly polarized beams. The compensation film stack is configured to convert the at least one elliptically polarized beam into at least one of the two circularly polarized beams.

### TECHNICAL FIELD

The present disclosure generally relates to optical devices and, more specifically, to a polarization grating having a large diffraction angle, a high efficiency, and a high degree of circular polarization output.

### BACKGROUND

Polarization gratings are efficient polarization-sensitive diffractive thin films that can diffract an input light at a high efficiency into the first orders with polarization selectivity. The polarization-sensitive diffractive thin film may be patterned to generate a suitable phase profile. Such a phase device is known as a Pancharatnam-Berry phase (“PBP”) device. PBP is a geometric phase (“GP”) related to changes in the polarization state experienced by a light while the light propagates in an optically anisotropic material. Such a geometric phase may be proportional to a solid angle defined by the polarization state along the light propagation path on the Poincarè sphere. In an optically anisotropic material, a transverse gradient of PBP may be induced by local rotations of the optic axis. When the thickness of an optically anisotropic film corresponds to a half-wave plate phase difference between the ordinary and the extraordinary lights, the PBP between two points across a light beam profile may be equal to two times of the relative rotation of the optic axis at the two points. Thus, the wavefront of the light may be polarization-dependent and may be configured by a spatial rotation of the optic axis within a film plane (i.e., an in-plane rotation).

A PBP device may include an optically anisotropic film, and a phase profile may be directly encoded into local orientations of the optic axis of the optically anisotropic film. PBP devices have features such as flatness, compactness, high efficiency, high aperture ratio, absence of on-axis aberrations, possibility of switching, flexible design, simple fabrication, and low cost, etc. Thus, PBP devices can be implemented in various applications such as portable or wearable optical devices or systems.

### SUMMARY OF THE DISCLOSURE

Consistent with an aspect of the present disclosure, a device is provided. The device includes a Pancharatnam-Berry phase (“PBP”) film stack configured to diffract an input beam as a first polarized beam and a second polarized beam having opposite handednesses. A combined diffraction efficiency of the PBP film stack for the first polarized beam and the second polarized beam is greater than a predetermined value. The device also includes a compensation film stack coupled with the PBP film stack, and configured to respectively convert the first polarized beam and the second polarized beam into a third polarized beam and a fourth polarized beam having the opposite handednesses. The first polarized beam and the second polarized beam include at least one elliptically polarized beam, and the third polarized beam and the fourth polarized beam are two circularly polarized beams. The compensation film stack is configured to convert the at least one elliptically polarized beam into at least one of the two circularly polarized beams.

Consistent with another aspect of the present disclosure, a method is provided. The method includes directing an input beam to a mask including a PBP film stack and a compensation film stack. The method also includes forwardly diffracting, by the PBP film stack, the input beam as a first polarized beam and a second polarized beam having opposite handednesses, a combined diffraction efficiency of the PBP film stack for the first polarized beam and the second polarized beam being greater than a predetermined value. The method also includes converting, by the compensation film stack, the first polarized beam and the second polarized beam into a third polarized beam and a fourth polarized beam, respectively. The first polarized beam and the second polarized beam include at least one elliptically polarized beam, and the third polarized beam and the fourth polarized beam are two circularly polarized beams. Converting, by the compensation film stack, the first polarized beam and the second polarized beam into the third polarized beam and the fourth polarized beam, respectively, includes converting, by the compensation film stack, the at least one elliptically polarized beam into at least one of the two circularly polarized beams.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A schematically illustrates a three-dimensional (“3D”) view of a conventional Pancharatnam-Berry phase (“PBP”) element;

FIG. 1B schematically illustrates in-plane orientations of optically anisotropic molecules in a portion of the PBP element shown in FIG. 1A;

FIG. 1C schematically illustrates a sectional view of a conventional PBP grating;

FIG. 1D illustrates design parameters and performance metrics of the conventional PBP grating shown in FIG. 1C having an in-plane pitch Pᵢₙ of 3 μm;

FIG. 2A schematically illustrates a diagram of a PBP device, according to an embodiment of the present disclosure;

FIG. 2B illustrates a compensation film that may be included in the PBP device shown in FIG. 2B, according to an embodiment of the present disclosure;

FIG. 2C schematically illustrates a diagram of a PBP film stack that may be included in the PBP device shown in FIG. 2A, according to an embodiment of the present disclosure;

FIG. 2D schematically illustrates a diagram of a PBP film stack that may be included in the PBP device shown in FIG. 2A, according to an embodiment of the present disclosure;

FIG. 3A schematically illustrates a diagram of a PBP device, according to an embodiment of the present disclosure;

FIG. 3B illustrates design parameters and performance metrics of a PBP film stack that may be included in the PBP device shown in FIG. 3A, according to an embodiment of the present disclosure;

FIG. 3C illustrates design parameters and performance metrics of the PBP device shown in FIG. 3A, according to an embodiment of the present disclosure;

FIG. 3D schematically illustrates a diagram of a PBP device, according to an embodiment of the present disclosure;

FIG. 3E illustrates design parameters and performance metrics of the PBP device shown in FIG. 3D, according to an embodiment of the present disclosure;

FIGS. 4A-4D schematically illustrate processes for fabricating a liquid crystal polarization hologram (“LCPH”) element using a disclosed PBP device as a mask, according to an embodiment of the present disclosure;

FIGS. 5A and 5B schematically illustrate processes for fabricating an LCPH element using a disclosed PBP device as a mask, according to an embodiment of the present disclosure;

FIG. 5C schematically illustrates processes for fabricating an LCPH element using a disclosed PBP device as a mask, according to an embodiment of the present disclosure;

FIG. 5D schematically illustrates processes for fabricating an LCPH element using a disclosed PBP device as a mask, according to an embodiment of the present disclosure;

FIGS. 6A and 6B schematically illustrate processes for fabricating an LCPH element using a disclosed PBP device as a mask, according to an embodiment of the present disclosure; and

FIG. 7 illustrates a flowchart showing a method for fabricating an LCPH element using a disclosed PBP device as a mask, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction or a normal of a surface of the film, layer, coating, or plate. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane. In some embodiments, an “out-of-plane” direction or orientation may form an acute or right angle with respect to the film plane.

The term “orthogonal” as in “orthogonal polarizations” or the term “orthogonally” as in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof.

The term “optic axis” may refer to a direction in a crystal. A light propagating in the optic axis direction may not experience birefringence (or double refraction). An optic axis may be a direction rather than a single line: lights that are parallel to that direction may experience no birefringence.

In the present disclosure, an angle of a beam (e.g., a diffraction angle of a diffracted beam or an incidence angle of an input beam) with respect to a normal of a surface can be defined as a positive angle or a negative angle, depending on the angular relationship between a virtual line representing a propagating direction of the beam and the normal of the surface. For example, when the virtual line representing the propagating direction of the beam deviates clockwise from the normal, the angle between the propagating direction and the normal may be defined as a negative angle, and when the virtual line representing the propagating direction of the beam deviates counter-clockwise from the normal, the angle between the propagating direction and the normal may be defined as a positive angle.

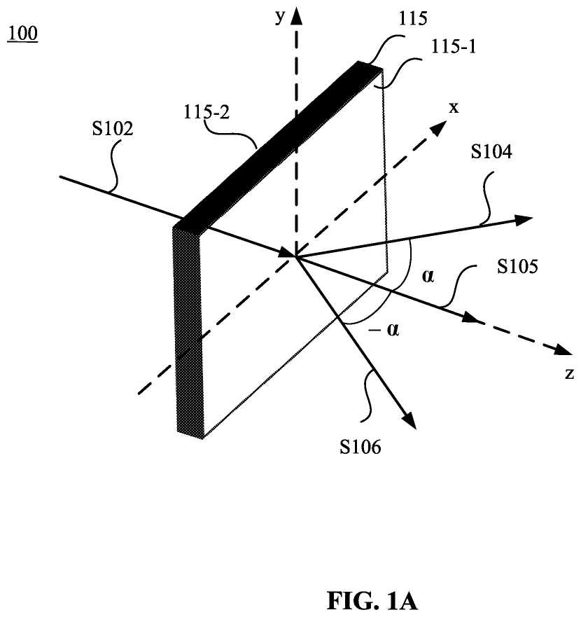

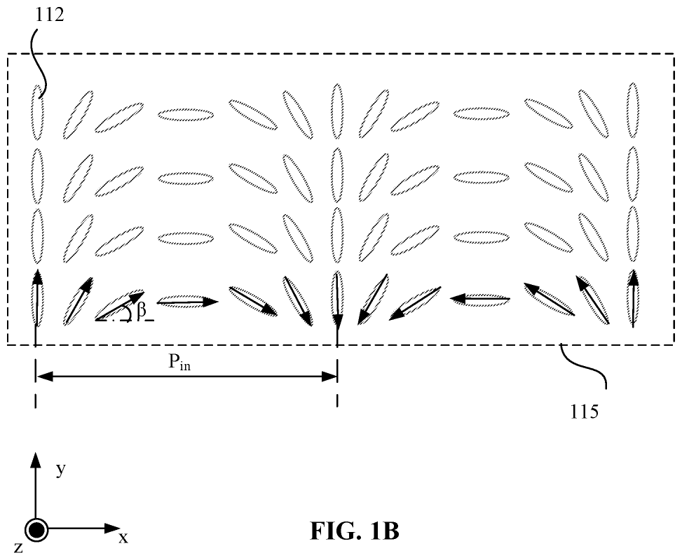

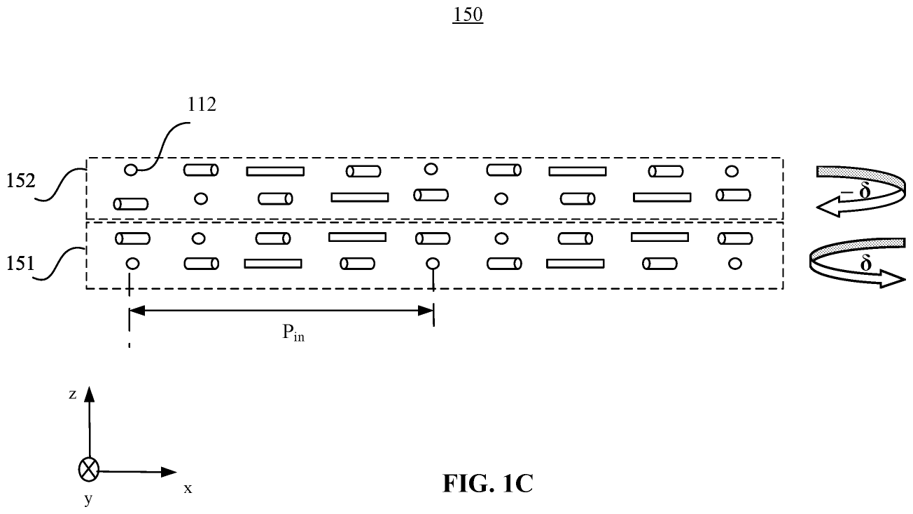

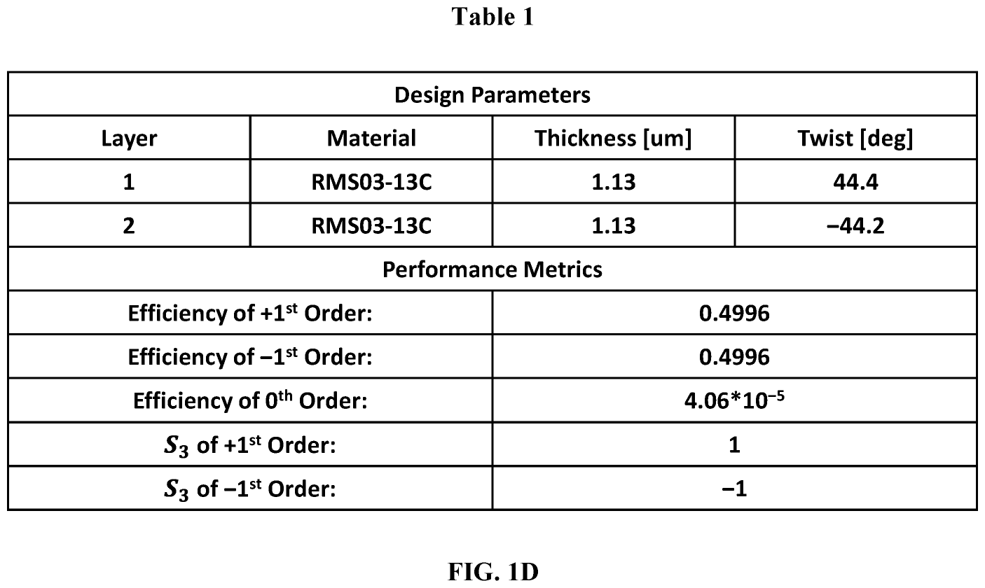

FIG. 1A illustrates a three-dimensional (“3D”) view of a conventional Pancharatnam-Berry phase (“PBP”) element 100 with a beam S102 incident onto the PBP element 100 along a +z-axis. As shown in FIG. 1A, the PBP element 100 may include a birefringent medium layer (e.g., a liquid crystal layer) 115. An optic axis of the birefringent medium layer 115 may be configured with a 3D orientational pattern to provide a polarization selective optical response. The birefringent medium layer 115 may include optically anisotropic molecules (e.g., rod-like LC molecules) 112 configured with a 3D orientational pattern. FIG. 1B illustrates the in-plane orientations of directors of the LC molecules 112 (or LC directors) within a film plane of the birefringent medium layer 115. The film plane may be parallel with at least one of a first surface 115-1 or a second surface 115-2 of the birefringent medium layer 115, and may be perpendicular to the thickness direction of the birefringent medium layer 115. As shown in FIG. 1B, the orientations of the LC directors located within the film plane of the birefringent medium layer 115 may exhibit a periodic rotation in a predetermined in-plane direction (e.g., an x-axis direction), forming a periodic in-plane orientation pattern (also referred to as a grating pattern) with a uniform (e.g., same) in-plane pitch Pᵢₙ. The in-plane pitch Pᵢₙ is defined as a distance along the in-plane direction (e.g., the x-axis direction) over which the orientations of the LC directors exhibit a rotation by 180°.

The PBP element 100 may be a type of a circular polarization grating (or a circular-polarization selective grating). Referring to FIG. 1A and FIG. 1B, the beam S102 may be a linearly polarized beam including a right-handed circularly polarized portion and a left-handed circularly polarized portion, the PBP element 100 may diffract the beam S102 as +1^{st} diffraction order beam S104 having a positive diffraction angle +α, a −1^{st} diffraction order S106 having a negative diffraction angle −α, and a 0^{th} diffraction order S105. The diffraction angles are defined with respect to the normal of the light outputting surface of the PBP element 100. The +1^{st} diffraction order S104 and the −1^{st} diffraction order S106 may be desirable diffraction orders, whereas the 0^{th} diffraction order S105 may be an undesirable, leaked diffraction order that causes noise. The in-plane pitch Pᵢₙ may determine, in part, the optical properties of the PBP element 100. As the in-plane pitch Pᵢₙ decreases, the diffraction angle of the ±1^{st} order diffracted beam may increase, whereas the diffraction efficiency of the PBP element 100 for the ±1^{st} order diffracted beam may decrease. The diffraction efficiency of the PBP element 100 may be substantially small when the in-plane pitch Pᵢₙ is substantially small.

The paraxial limit for a PBP element may be described by a dimensionless parameter

$$ρ = \frac{2 * {λ}^{2}}{\overline{n} * Δ n * Λ} ,$$

where

$$\overline{n} = \frac{1}{2} * ( {n}_{o} + {n}_{e} )$$

is the average refractive index of a birefringent medium (e.g., an LC material) used in the PBP element, no and ne are ordinary refractive index and extraordinary refractive index of the birefringent medium, respectively, λ is a wavelength of an incident light of the PBP element, and A is the in-plane pitch Pᵢₙ of the PBP element. The paraxial limit may be satisfied when the parameter ρ is equal to or less than 1 (i.e., ρ≤1), and the paraxial limit may be exceeded when the parameter ρ is greater than 1 (i.e., ρ>1). The PBP element may operate in a paraxial domain when the paraxial limit is satisfied, and operate in a non-paraxial domain when the paraxial limit is exceeded.

When the PBP element 100 has a small diffraction angle or a large f-number, the paraxial limit (i.e., ρ≤1) may be satisfied, and the PBP element 100 may be operated in the paraxial domain for an operation wavelength range, e.g., the visible wavelength range. Thus, it may be easy to design the PBP element 100 to have both a high efficiency and a high degree of circular polarization (“DoCP”) output for the desired diffraction orders, e.g., ±1^{st} order diffracted beams, as the paraxial relationship between the efficiency and DoCP of a diffracted beam has already been established. FIG. 1C illustrates an x-z sectional view of a conventional PBP grating 150, and FIG. 1D illustrates a Table 1 showing design parameters and performance metrics of the conventional PBP grating 150 show in FIG. 1C having an in-plane pitch Pᵢₙ of 3 μm and an operation wavelength of 355 nm, in which the paraxial limit may be satisfied (i.e., ρ≤1). The conventional PBP grating 150 show in FIG. 1C may operate in the paraxial domain. As shown in FIG. 1C, the PBP grating 150 may include a stack of a first PBP film 151 and a second PBP film 152, each of which may be similar to the PBP element 100 shown in FIG. 1A. Each PBP film 151 or 152 may have a thickness of a half-wave plate at the operation wavelength. Each PBP film 151 or 152 may have a dual-twist structure, in which the LC directors rotate (or twist) in both an in-plane direction (e.g., an x-axis direction) and an out-of-plane direction (e.g., a z-axis direction) of the PBP film 151 or 152. That is, the orientation of the LC director at a local point of the PBP film 151 or 152 depends on both the x position and the z position of the local point.

In FIG. 1C, within the film plane of each PBP film 151 or 152, the LC directors may rotate (or twist) along the in-plane direction (e.g., the x-axis direction) to form a periodic in-plane orientation pattern with a uniform in-plane pitch Pᵢₙ, similar to that shown in FIG. 1B. In the volume of each PBP film 151 or 152, the LC directors may rotate (or twist) along the out-of-plane direction (e.g., the thickness direction) in a predetermined rotation direction, e.g., a clockwise direction or a counter-clockwise direction. Accordingly, the rotation of the orientations of the LC directors (or rotation of the LC directors) along the thickness direction of the PBP film 151 or 152 may exhibit a handedness, e.g., right handedness or left handedness. The twist of LC directors in the thickness direction may also be referred to as vertical twist, which may be described in terms of twist angle.

In the present discourse, a twist angle of a single PBP film refers to a total azimuthal angle variation over the thickness direction of the single PBP film, in which the rotation of the LC directors along the thickness direction of the PBP film may exhibit a constant handedness, e.g., the right handedness or left handedness. The twist angle of the single PBP film can be defined as a positive angle or a negative angle, depending on the handedness of the rotation of the LC directors along the thickness direction of the PBP film. For example, the twist angle may be defined as a positive angle when the rotation of the LC directors along the thickness direction exhibits the right handedness, the twist angle may be defined as a negative angle when the rotation of the LC directors long the along the thickness direction exhibits the left handedness.

Through configuring the thicknesses and the twist angles of the PBP films 151 and 152, the PBP grating 150 may provide a high efficiency and a high DoCP output. FIG. 1D shows that the first PBP film 151 and the second PBP film 152 have the same thickness of 1.13 μm, and the same in-plane pitch Pᵢₙ of 3 μm. The first PBP film 151 and the second PBP film 152 have opposite rotation directions of the LC directors along the thickness direction, and opposite twist angles of +44.4 degrees and −44.4 degrees. The PBP grating 150 may be fabricated by forming a first LC mixture layer on a substrate with an alignment layer, photopolymerizing the first LC mixture layer to form the first PBP film 151, forming a second LC mixture layer on the first PBP film 151, and photopolymerizing the second LC mixture layer to form the second PBP film 152. The first LC mixture layer may include an LC precursor and a controlled amount of first chiral dopants having a first handedness. The second LC mixture layer may include an LC precursor and a controlled amount of second chiral dopants having a second handedness opposite to the first handedness.

FIG. 1D shows that the PBP grating 150 diffracts an input beam to the +1^{st} diffraction order at a first diffraction efficiency of 0.4996, and diffracts the input beam to the −1^{st} diffraction order at a second diffraction efficiency of 0.4996. The combined diffraction efficiency of the PBP grating 150 for the +1^{st} diffraction order and the −1^{st} diffraction order, i.e., the sum of the first diffraction efficiency and the second diffraction efficiency, is greater than 99%. The diffraction efficiency for the 0^{th} diffraction order is less than 0.5%. In addition, each of the +1^{st} diffraction order and the −1^{st} diffraction order has a high DoCP output. The DoCP output of a light beam is evaluated by the absolute value of Stokes parameter S₃. A person skilled in the art understands that a right-handed circularly polarized beam has the Stokes parameter S₃=1.0, and a left-handed circularly polarized beam has the Stokes parameter S₃=−1.0. As the Stokes parameter S₃ approaches 1, the +1^{st} diffraction order approaches a right-handed circularly polarized beam. As the Stokes parameter S₃ approaches −1, the −1^{st} diffraction order approaches a left-handed circularly polarized beam. Table 1 in FIG. 1D shows that the DoCP output of each of the +1^{st} diffraction order and the −1^{st} diffraction order is greater than 0.99 (indicated by S₃ being 1 and −1 in Table 1). That is, both the +1^{st} diffraction order and the −1^{st} diffraction order are substantially circularly polarized beams.

When the in-plane pitch Pᵢₙ of a conventional PBP grating is reduced to 1 μm or less, the diffraction angle may be significantly increased. However, the paraxial limit may be exceeded (i.e., ρ>1), and the conventional PBP grating may operate in the non-paraxial domain. Thus, it may be challenging to render the conventional PBP grating to have a high efficiency and a high DoCP output. Instead, only one of the efficiency and the DoCP output of the desirable orders (e.g., +1^{st} diffraction order, −1^{st} diffraction order) may be controlled. For example, when the conventional PBP grating is designed to have a high efficiency for the desirable orders, the DoCP output of the desirable orders may be low. When the conventional PBP grating is designed to have a high DoCP output of the desirable orders, the efficiency for the desirable orders may be low. Increasing the number of PBP films included in the conventional PBP grating may improve the efficiency and the DoCP output of the desirable orders. A conventional PBP grating having a smaller in-plane pitch Pᵢₙ may need a larger number of PBP films for achieving substantially the same efficiency and the DoCP output of the desirable orders, which may increase the fabrication complexity and tolerancing immensely.

In view of the limitations in conventional technologies, the present disclosure provides PBP devices or components having a large diffraction angle, a high diffraction efficiency, and a high degree of circular polarization (“DoCP”) output. The disclosed PBP device or component may have a reduced manufacturing complexity and manufacturing cost, and an improved level of correction. The disclosed PBP device or component may be used for various applications, e.g., used as a mask for proximity duplication of liquid crystal polarization holograms (“LCPHs”) with a fine in-plane pitch (e.g., 200 nm to 800 nm).

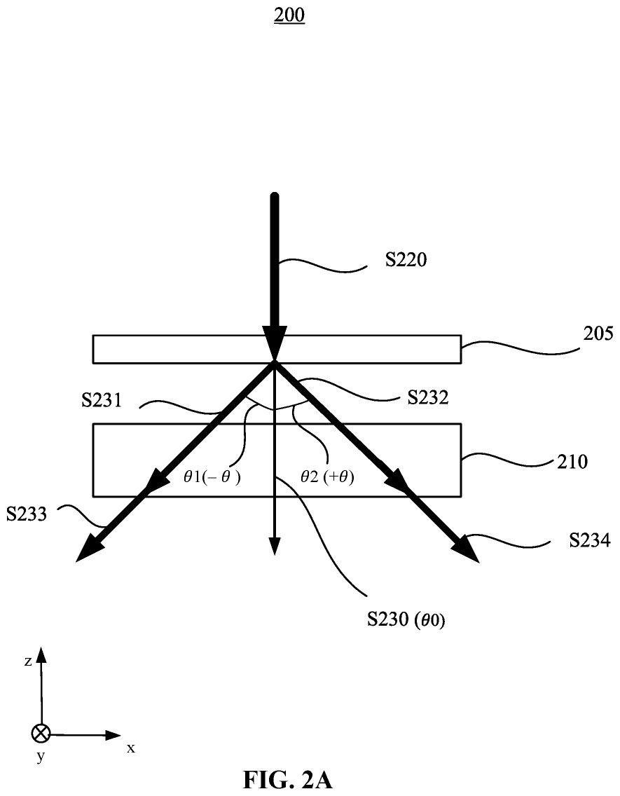

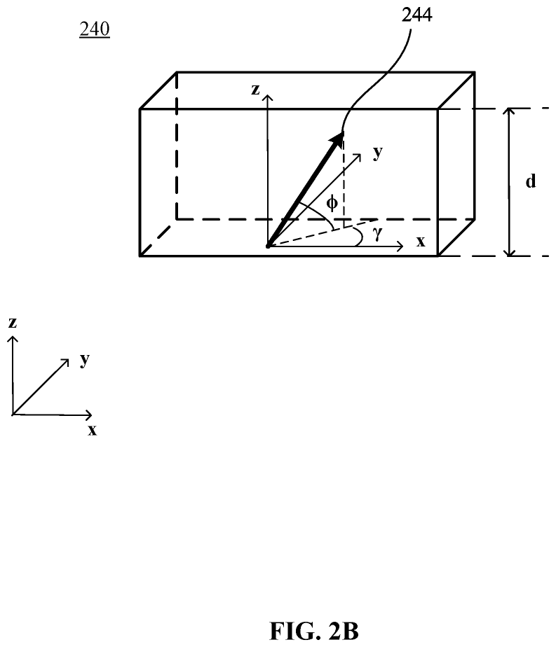

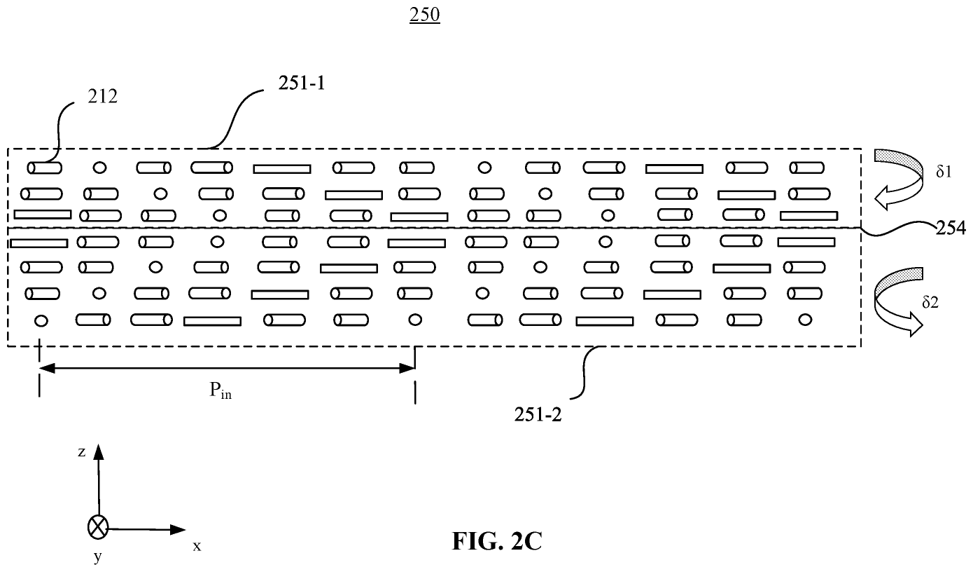

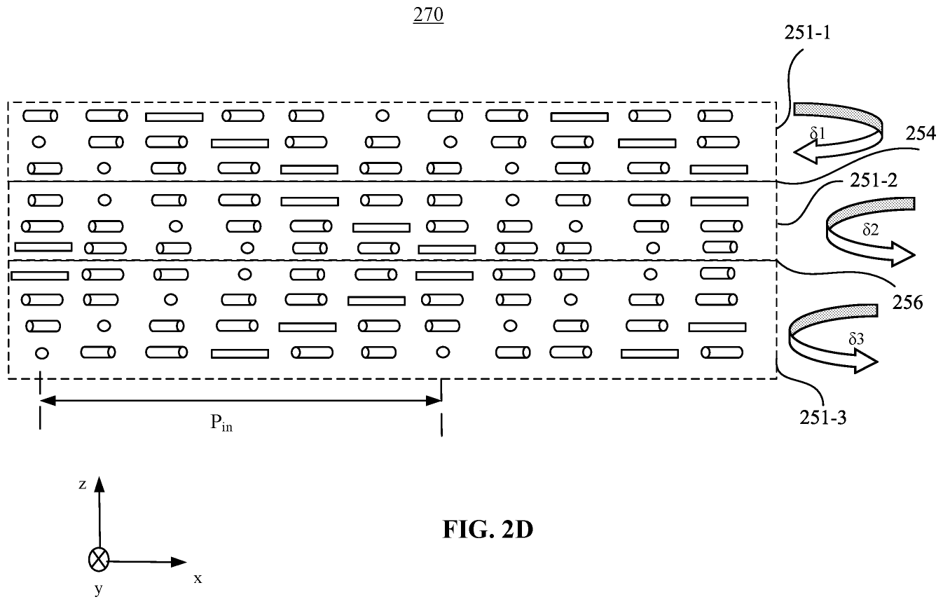

FIG. 2A schematically illustrates an x-z sectional view of a PBP device or component 200, according to an embodiment of the present disclosure. The PBP device 200 may be configured to provide a large diffraction angle, a high efficiency, and a high DoCP output. The PBP device 200 may be configured to operate in the non-paraxial domain for a predetermined operation wavelength range, e.g., visible wavelength range. As shown in FIG. 2A, the PBP device 200 may include a PBP film stack 205 and a compensation film stack 210 coupled with the PBP film stack 205. In the embodiment shown in FIG. 2A, the PBP film stack 205 and the compensation film stack 210 are shown as being spaced apart from one another by a gap. In some embodiments, the PBP film stack 205 and the compensation film stack 210 may be stacked without a gap (e.g., through direct contact). For illustrative purposes, the PBP film stack 205 and the compensation film stack 210 are shown as having flat surfaces. In some embodiments, the PBP film stack 205 and/or the compensation film stack 210 may have curved surfaces.

The PBP film stack 205 may include at least one PBP film, and the compensation film stack 210 may include at least one compensation film. In some embodiments, the PBP film stack 205 may include a plurality of PBP films, and the compensation film stack 210 may include a plurality of compensation films. Each PBP film may be configured to operate in a non-paraxial domain (i.e., ρ>1) for the operation wavelength range (e.g., visible wavelength rage) of the PBP device 200. A light source (not shown) may output an input beam S220 toward the PBP film stack 205. The input beam S220 may have a wavelength λ within the operation wavelength range of the PBP film stack 205. The PBP film stack 205 may be configured to forwardly deflect (e.g., diffract) the input beam S220 as a plurality of signal beams S231 and S232, which are desirable orders, and a leaked beam S230, which is an undesirable order that causes noise. Each PBP film in the PBP film stack 205 may be configured with an in-plane orientation pattern having an in-plane pitch of 1 μm or less, such that the signal beams S231 and S232 have large diffraction angles.

In some embodiments, the PBP film stack 205 may be configured to control the efficiencies of the signal beams S231 and S232, rather than the polarization states of the signal beams S231 and S232. For example, the materials, structures, and parameters of each PBP film in the PBP film stack 205 may be specifically configured, such that the PBP film stack 205 provides a predetermined high efficiency for the signal beams S231 and S232, and a predetermined low efficiency for the leaked beam S230. As the PBP film stack 205 is designed to provide high efficiencies for the signal beams S231 and S232, the polarization states of the signal beams S231 and S232 may not be controlled, and may deviate from desirable, predetermined polarization states.

The compensation film stack 210 may be configured to correct the polarization states of the signal beams S231 and S232 to the desirable, predetermined polarization states, while transmitting the signal beams S231 and S232. For example, the compensation film stack 210 may convert the signal beams S231 and S232 that are substantially elliptically polarized beams into signal beams S233 and S234 that are substantially circularly polarized beams. Thus, when the PBP device 200 deflects the input beam S220 as the signal beams S233 and S234, the PBP film stack 205 may be configured to control the diffraction angle and the efficiency of the signal beams S233 and S234, and the compensation film stack 210 may be configured to control the polarization states of the signal beams S233 and S234. Thus, the PBP film stack 205 and the compensation film stack 210 together may provide a large diffraction angle, a high efficiency and a high DoCP output for the signal beams S233 and S234, and a low efficiency for the leaked beam S230.

In some embodiments, the input beam S220 of the PBP film stack 205 may be at least partially polarized. For discussion purposes, in FIG. 2A, the input beam S220 may be a linearly polarized beam including a right-handed circularly polarized portion and a left-handed circularly polarized portion. In some embodiments, the right-handed circularly polarized portion and the left-handed circularly polarized portion of the input beam S220 may have a substantially same light intensity. The PBP film stack 205 may be configured to forwardly deflect the input beam S220 as the signal beam S231 having a deflection angle θ₁ (referred to as a first signal beam having a first deflection angle θ₁), the signal beam S232 having a deflection angle θ₂ (referred to as a second signal beam having a second deflection angle θ₂), and the leaked beam S230 having a deflection angle θ₀. The deflection angle θ₀ of the leaked beam S230 may be equal to the incidence angle of the input beam S220.

The deflection angles θ₁ and θ₂ may be respectively defined as a negative angle and a positive angle, with respect to a normal of the light outputting surface of the PBP film stack 205. In some embodiments, the deflection angles θ₁ and θ₂ may have opposite signs and different absolute values. In some embodiments, the deflection angles θ₁ and θ₂ may have opposite signs and the same absolute value. The deflection angles θ₁ and θ₂ may be different from the incidence angle of the input beam S220. The deflection angles θ₁ and θ₂ may be determined, in part, by the incidence angle of the input beam S220, the wavelength λ of the input beam S220, and the in-plane pitch Pᵢₙ of the PBP film included in the PBP film stack 205. Thus, the signal beam S231 or S232 may carry the information or properties of the PBP film stack 205, and the leaked beam S230 may not carry (or may carry an insignificant amount of) the information or properties of the PBP film stack 205.

In some embodiments, the first signal beam S231 and the second signal beam S232 may be polarized beams. In some embodiments, a first Stokes parameter S₃ of the first signal beam S231 and a second Stokes parameter S₃ of the second signal beam S232 may have opposite signs. In some embodiments, the first Stokes parameter S₃ of the first signal beam S231 and the second Stokes parameter S₃ of the second signal beam S232 may have different absolute values, and each absolute value may be less than 1. For example, the first signal beam S231 and the second signal beam S232 may be elliptically polarized beams with opposite handednesses.

The efficiency of the PBP film stack 205 associated with a specific output beam is calculated as a ratio between an output light intensity of the specific output beam and an input light intensity of an input beam. In the disclosed embodiments, the combined efficiency of the PBP film stack 205 for the first signal beam S231 and the second signal beam S232 (i.e., the sum of a first diffraction efficiency for the first signal beam S231 and a second diffraction efficiency for the second signal beam S232) may be equal to or greater than a first predetermined value, whereas the efficiency of the PBP film stack 205 for the leaked beam S230 may be equal to or less than a second predetermined value. For example, the first predetermined value may be 99.5%, 99.6%, 99.7%, 99.8%, 99.9%, or 99.95%, and the second predetermined value may be 0.5%, 0.4%, 0.3%, 0.2%, 0.1%, or 0.05%. In some embodiments, the PBP film stack 205 may be configured to provide a substantially equal efficiency for the first signal beam S231 and the second signal beam S232. That is, the efficiency of the PBP film stack 205 for each of the first signal beam S231 and the second signal beam S232 may be equal to or greater than half of the first predetermined value. In some embodiments, the PBP film stack 205 may be configured to provide different efficiencies for the first signal beam S231 and the second signal beam S232.

In some embodiments, as shown in FIG. 2A, the PBP film stack 205 may be configured to forwardly diffract the input beam S220 as a plurality of diffracted beams, and the first signal beam S231 may be the −1^{st} order diffracted beam (or −1^{st} diffraction order), the second signal single beam S232 may be the +1^{st} order diffracted beam (or +1^{st} diffraction order), and the leaked beam S230 may be the 0^{th} order diffracted beam (or 0^{th} diffraction order). Thus, the efficiency of the PBP film stack 205 for a specific output beam may also be considered as a diffraction efficiency for a specific diffracted beam. For discussion purposes, FIG. 2A shows that the input beam S220 is normally incident onto the PBP film stack 205, the leaked beam S230 has the zero degree diffraction angle, the first signal beam S231 has a negative diffraction angle −θ, and the second signal single beam S232 has a positive diffraction angle +θ.

The first signal beam S231, the second signal beam S232, and the leaked beam S230 may propagate toward the compensation film stack 210. The compensation film stack 210 is presumed to substantially maintain the propagation directions and light intensities of the first signal beam S231, the second signal beam S232, and the leaked beam S230. The compensation film stack 205 may be configured to convert the first signal beam S231 having the first Stokes parameter S3 into a third signal beam S233 having a third Stokes parameter S3, and the convert the second signal beam S232 having the second Stokes parameter S3 into a fourth signal beam S234 having a fourth Stokes parameter S3. The third Stokes parameter S3 and the fourth Stokes parameter S3 may have opposite signs. In some embodiments, the third Stokes parameter S3 and the first Stokes parameter S3 may have the same sign, and the absolute value of the third Stokes parameter S3 may be greater than the absolute value of the first Stokes parameter S3. In some embodiments, the fourth Stokes parameter S3 and the second Stokes parameter S3 may have the same sign, and the absolute value of the fourth Stokes parameter S3 may be greater than the absolute value of the second Stokes parameter S3.

In some embodiments, each of the third Stokes parameter S3 and the fourth Stokes parameter S3 may have the absolute value that is substantially close to 1. That is, each of the third signal beam S233 and the fourth signal beam S234 may have a high DoCP output that is substantially close to 1. In some embodiments, one of the third Stokes parameter S3 and the fourth Stokes parameter S3 may be substantially close to 1, and the other of the third Stokes parameter S3 and the fourth Stokes parameter S3 may be substantially close to −1. That is, the signal beams S233 and S234 may be substantially circularly polarized beams with opposite handednesses.

The compensation film stack 210 may include one or more compensation films. FIG. 2B illustrates a compensation film 240 that may be included in the compensation film stack 210, according to an embodiment of the present disclosure. The compensation film 240 may be a uniaxial plate (e.g., an A-plate, a C-plate, or an oblique compensation plate (“O-plate”), etc.), a biaxial plate, or any other suitable compensation film. The compensation film 240 may have a positive anisotropy, a negative anisotropy, or a biaxial anisotropy. In some embodiments, the compensation film stack 210 may include one compensation film 240 or a plurality of compensation films 240. In some embodiments, at least two of the compensation films 240 may be compensation films of the same type. In some embodiments, at least two of the compensation films 240 may be compensation films of different types.

An orientation of a predetermined principal axis 244 of the compensation film 240 may be referred to as an orientation of the compensation film 240. In some embodiments, the predetermined principal axis 244 may be a fast axis (also referred to as 244 for discussion purposes) of the compensation film 240. The orientation of the fast axis 244 may be characterized by two angles: a pretilt angle ϕ with respect to a film plane of the compensation film 240, and an azimuthal angle γ with respect to a predetermined in-plane direction within the film plane of the compensation film 240. The azimuthal angle γ may be an angle of a projection of the fast axis 244 onto the film plane with respect to the predetermined in-plane direction within the film plane. For discussion purposes, FIG. 2B shows that the predetermined in-plane direction is an x-axis direction, the film plane of the compensation film 240 is an x-y plane, and an out-of-plane direction (e.g., thickness direction) of the compensation film 240 is a z-axis direction.

In some embodiments, the fast axis 244 of the compensation film 240 may be within the film plane of the compensation film 240, and the pretilt angle ϕ may be zero. In some embodiments, the fast axis 244 of the compensation film 240 may be perpendicular to the film plane of the compensation film 240, e.g., along the thickness direction of the compensation film 240, and the pretilt angle ϕ may be about 90°. In some embodiments, the fast axis 244 of the compensation film 240 may be oblique to the film plane of the compensation film 240, and the and the pretilt angle ϕ may be between 0° and 90°. In some embodiments, at least two of the compensation films 240 may be configured with the same orientation of the predetermined principal axis (e.g., fast axis). In some embodiments, at least two of the compensation films 240 may be configured with different orientations of the predetermined principal axes (e.g., fast axes).

In some embodiments, the orientation of each compensation film 240 (e.g., the pretilt angle and the azimuthal angle of the fast axis) and a phase retardance provided by each compensation film 240 (e.g., the thickness and birefringence) at the operation wavelength of the PBP device 200 may be configured, such that the compensation film stack 210 may be configured to provide a first predetermined phase retardance to the first signal beam S231 and a second predetermined phase retardance to the second signal beam S232. Thus, the compensation film stack 210 may respectively convert the first signal beam S231 and the second signal beam S232 into the third signal beam S233 and the fourth signal beam S234 with desirable polarization states.

FIG. 2C schematically illustrates an x-z sectional view of a PBP film stack 250 that may be included in the PBP device 200 shown in FIG. 2A, according to an embodiment of the present disclosure. The PBP film stack 250 may be an embodiment of the PBP film stack 205 shown in FIG. 2A. As shown in FIG. 2C, the PBP film stack 250 may include a stack of a first PBP film 251-1 and a second PBP film 251-2 (collectively referred to as 251). The PBP film 251 may include sub-wavelength structures (e.g., a metamaterial), a birefringent material (e.g., an LC material), a photo-refractive holographic material (e.g., a photosensitive polymer), or any combination thereof. In some embodiments, the PBP film 251 may be fabricated based on an isotropic or anisotropic material. In some embodiments, the PBP film 251 may be fabricated based on a birefringent medium, e.g., an LC material, which may have an intrinsic orientational order of optically anisotropic molecules that can be locally controlled. In some embodiments, the PBP film 251 may be fabricated based on a photosensitive polymer, such as an amorphous polymer, an LC polymer, etc., which may generate an induced (e.g., photo-induced) optical anisotropy and/or an induced (e.g., photo-induced) optic axis orientation when subjected to a polarized light irradiation.

The PBP film 251 may be configured with a dual-twist structure. In some embodiments, the optic axis of the PBP film 251 may periodically or non-periodically rotate (or twist) in at least one in-plane direction, such as at least one in-plane linear direction, in at least one in-plane radial direction, in at least one in-plane circumferential (e.g., azimuthal) direction, or a combination thereof. In some embodiments, the optic axis of the PBP film 251 may also rotate (or twist) in an out-of-plane direction (e.g., the thickness direction of the PBP film 251) in a predetermined rotation direction, e.g., a clockwise direction or a counter-clockwise direction. Accordingly, the rotation of the optic axis of the PBP film 251 along the thickness direction of the PBP film 251 may exhibit a handedness, e.g., right handedness or left handedness. The twist of the optic axis of the PBP film 251 in the out-of-plane direction (e.g., the thickness direction of the PBP film 251) may also be described in terms of the twist angle.

In some embodiments, the PBP film 251 may include a birefringent medium (e.g., an LC material) including optically anisotropic molecules (e.g., rod like LC molecules) 212, and the dual-twist structure of the PBP film 251 may be configured through configuring a 3D orientational pattern of the LC molecules 212. For discussion purpose, FIG. 2C shows that the directors of the LC molecules 212 within a film plane of the PBP film 251 are configured with a periodic in-plane orientation pattern with a constant in-plane pitch Pᵢₙ (similar to that shown in FIG. 1B), and the directors of the LC molecules 212 in the out-of-plane direction of the PBP film 251 are configured with a rotation in a predetermined rotation direction, e.g., a clockwise direction or a counter-clockwise direction. In some embodiments, the directors of the LC molecules 212 within a film plane of the PBP film 251 are configured with another suitable in-plane orientation pattern, such as an in-plane orientation pattern with a varying pitch in at least two opposite predetermined in-plane directions. Such an in-plane orientation pattern may be referred to as a lens pattern, and the PBP film 251 may function as a diffractive lens. The diffractive lens may be considered as a diffraction grating with a non-zero optical power.

In some embodiments, the first PBP film 251-1 and the second PBP film 251-2 may be configured with the same in-plane orientation pattern, e.g., the same periodic in-plane orientation pattern with the same in-plane pitch Pᵢₙ. In some embodiments, the optic axes of the first PBP film 251-1 and the second PBP film 251-2 in the respective thickness directions may be configured with opposite rotation directions. In some embodiments, a first twist angle δ₁ of the first PBP film 251-1 and a second twist angle δ₂ of the second PBP film 251-2 may have opposite signs. In some embodiments, the first twist angle δ₁ of the first PBP film 251-1 and the second twist angle δ₂ of the second PBP film 251-2 may have different absolute values.

The PBP film 251 may be configured to provide a half-wave phase retardance at the operation wavelength of the PBP film stack 250. The thickness and the birefringence of the PBP film 251 may satisfy the equation d*Δn=λ*(2*m+1)/2, where d is the thickness of the PBP film 251, Δn is the birefringence of the PBP film 251, m is an integer that is equal to or greater than 0, and λ is the operation wavelength of the PBP film stack 250. In some embodiments, when the first PBP film 251-1 and the second PBP film 251-2 include LC materials of the same birefringence, a first thickness d₁ of the first PBP film 251-1 may be different from a second thickness d₂ of the second PBP film 251-2. In some embodiments, when the first PBP film 251-1 and the second PBP film 251-2 include LC materials of different birefringence, the first thickness d₁ may be the same as or different from the second thickness d₂.

Through matching the phase condition (e.g., half-wave phase retardance at the operation wavelength of the PBP film stack 250) and properly controlling the twist angle of each PBP film 251 in the PBP film stack 250, the combined efficiency of the PBP film stack 250 for the first signal beam S231 and the second signal beam S232 (i.e., the sum of a first diffraction efficiency for the first signal beam S231 and a second diffraction efficiency for the second signal beam S232) may be equal to or greater than the first predetermined value. In some embodiments, the PBP film stack 250 may be fabricated by forming a first LC mixture layer having the first thickness d₁ on a substrate with an alignment layer, photopolymerizing the first LC mixture layer to form the first PBP film 251-1, forming a second LC mixture layer having the second thickness d₂ on the first PBP film 251-1, and photopolymerizing the second LC mixture layer to form the second PBP film 251-2. The first LC mixture layer may include an LC precursor and a first amount of first chiral dopants having a first handedness. The first twist angle δ₁ of the first PBP film 251-1 may be controlled by controlling the first amount of first chiral dopants. The second LC mixture layer may include an LC precursor and a second amount of second chiral dopants having a second handedness opposite to the first handedness. The second twist angle δ₂ of the second PBP film 251-2 may be controlled by controlling the first amount of first chiral dopants. At an interface 254 between the neighboring PBP films 251-1 and 251-2, the optic axes of the neighboring PBP films 251-1 and 251-2 may be continuous (e.g., may have substantially the same orientations at the interface 254).

FIG. 2D schematically illustrates an x-z sectional view of a PBP film stack 270 that may be included in the PBP device 200 shown in FIG. 2A, according to an embodiment of the present disclosure. The PBP film stack 270 may be an embodiment of the PBP film stack 205 shown in FIG. 2A. The PBP film stack 270 may include elements that are similar to the PBP film stack 250 shown in FIG. 2C. Detailed descriptions of the same or similar elements included in the PBP film stack 270 may refer to the above description rendered in connection with FIG. 2C. As shown in FIG. 2D, the PBP film stack 270 may include a stack of three PBP films: the first PBP film 251-1, the second PBP film 251-2, and a third PBP film 251-3 (collectively referred to as 251).

In some embodiments, the first PBP film 251-1, the second PBP film 251-2, and the third PBP film 251-3 may be configured with the same in-plane orientation pattern, e.g., the same periodic in-plane orientation pattern with the same in-plane pitch Pᵢₙ. In some embodiments, in the respective thickness directions of the PBP films 251-1, 251-2 and 251-3, two of the PBP films 251-1, 251-2 and 251-3 may be configured with the same rotation direction of the optic axis that is different from the rotation direction of the optic axis of the remaining one. Among the first twist angle δ₁ of the first PBP film 251-1, the second twist angle δ₂ of the second PBP film 251-2, and a third twist angle δ₃ of the third PBP film 251-3, two of the first twist angle δ₁, the second twist angle δ₂, the third twist angle δ₃ may have the same sign that is opposite to the sign of the remaining one. For discussion purposes, FIG. 2D shows that in the respective thickness directions of the PBP films 251-1, 251-2 and 251-3, the rotation direction of the optic axis of the first PBP film 251-1 is left-handed, and the rotation directions of the optic axes of the second PBP film 251-2 and the third PBP film 251-3 are right-handed. For example, the first twist angle δ₁ may have a negative value, and the second twist angle δ₂ and the third twist angle δ₃ may have positive values.

In some embodiments, the first thickness d₁ of the first PBP film 251-1, the second thickness d₂ of the second PBP film 251-2, and a third thickness d₃ of the third PBP film 251-3 may be different from one another. In some embodiments, at least two of the first thickness d₁ of, the second thickness d₂, and the third thickness d₃ may be the same. In some embodiments, the absolute values of the first twist angle δ₁, the second twist angle δ₂, the third twist angle δ₃ may be different from one another. In some embodiments, at least two of the first twist angle δ₁, the second twist angle δ₂, the third twist angle δ₃ may have the same absolute value.

Through matching the phase condition (e.g., half-wave phase retardance at the operation wavelength of the PBP film stack 270) and properly controlling the twist angle of each PBP film 251 in the PBP film stack 270, the combined efficiency of the PBP film stack 270 for the first signal beam S231 and the second signal beam S232 (i.e., the sum of a first diffraction efficiency for the first signal beam S231 and a second diffraction efficiency for the second signal beam S232) may be equal to or greater than the first predetermined value. In some embodiments, the PBP film stack 270 may be fabricated by forming a third LC mixture layer having a third thickness d₃ on the second PBP film 251-2, and photo-polymerizing the third LC mixture layer to form the third PBP film 251-3. The third LC mixture layer may include an LC precursor and a third amount of the first chiral dopants or second chiral dopants. The third twist angle δ₃ of the third PBP film 251-3 may be controlled by controlling the third amount of the first chiral dopants or second chiral dopants doped into the LC precursor. At an interface 256 between the neighboring PBP films 251-2 and 251-3, the optic axes of the neighboring PBP films 251-2 and 251-3 may have continuous orientations (e.g., may have substantially the same orientations at the interface 256).

The number of the PBP films included in the PBP film stack 250 shown in FIG. 2C and the number of the PBP films included in the PBP film stack 270 shown in FIG. 2D are for illustrative purposes. In some embodiments, the PBP film stack 250 or the PBP film stack 270 may include any suitable number of PBP films, such as four, five, or six, and so on.

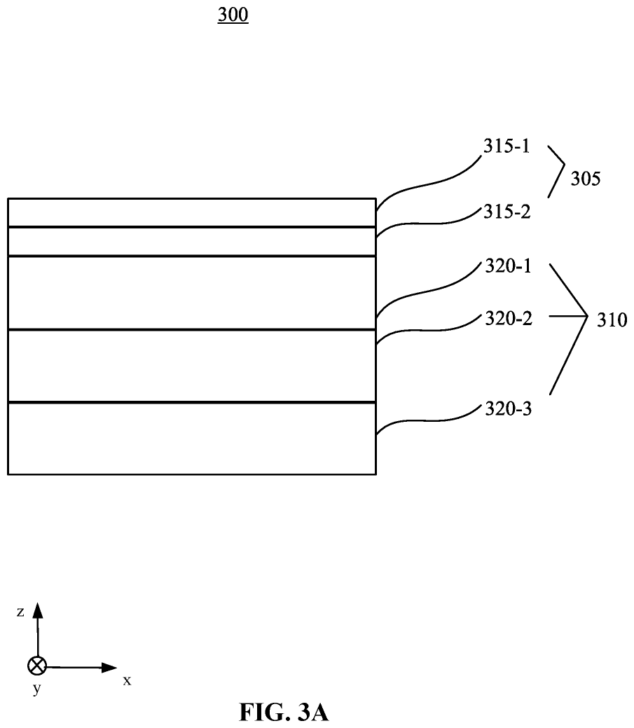

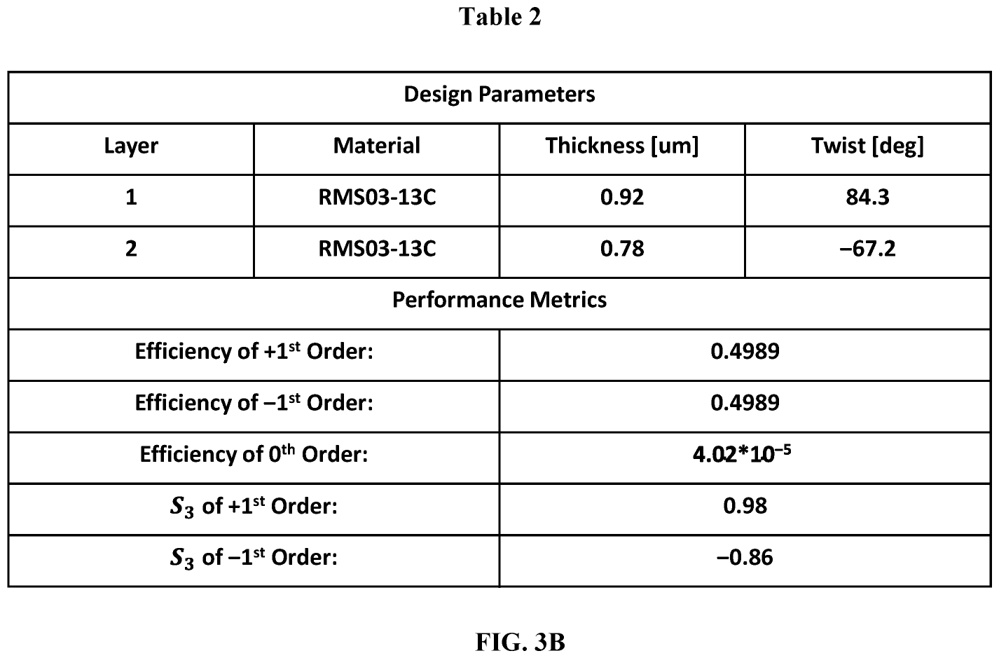

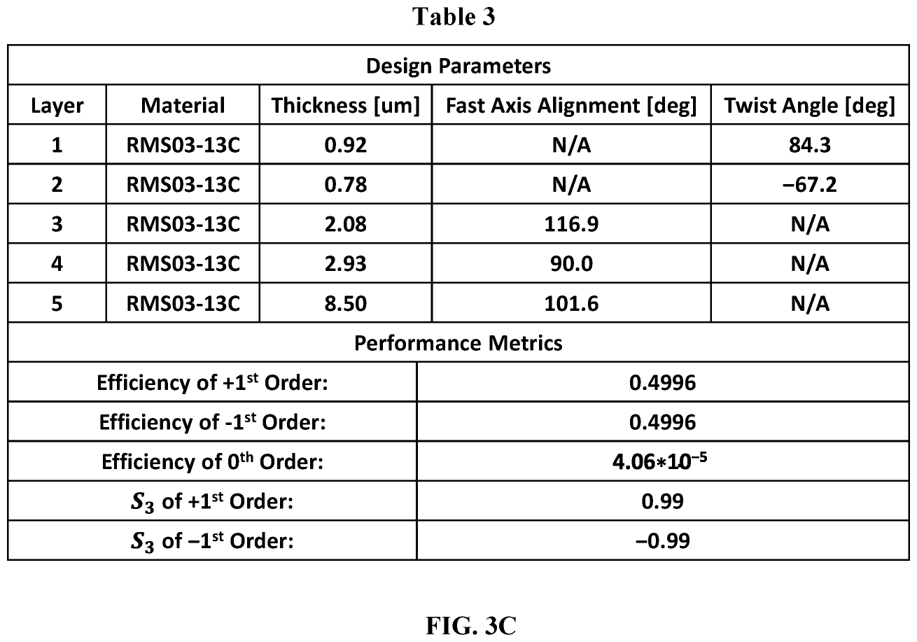

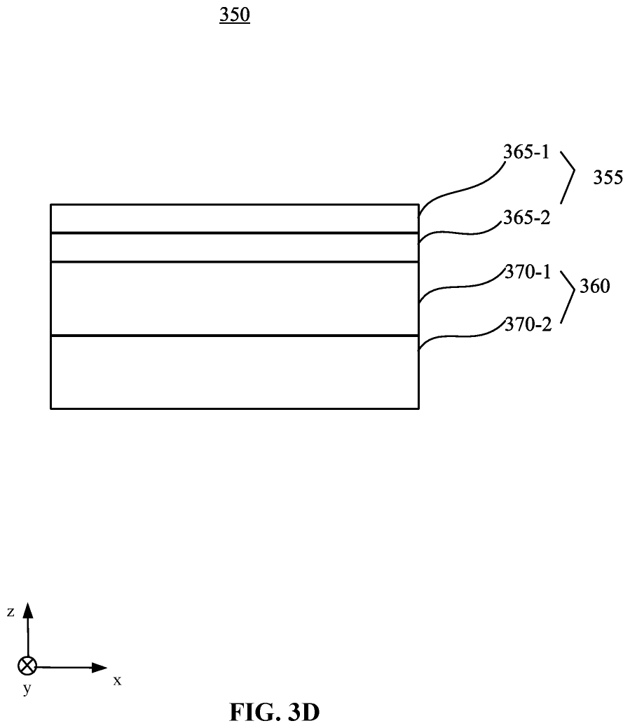

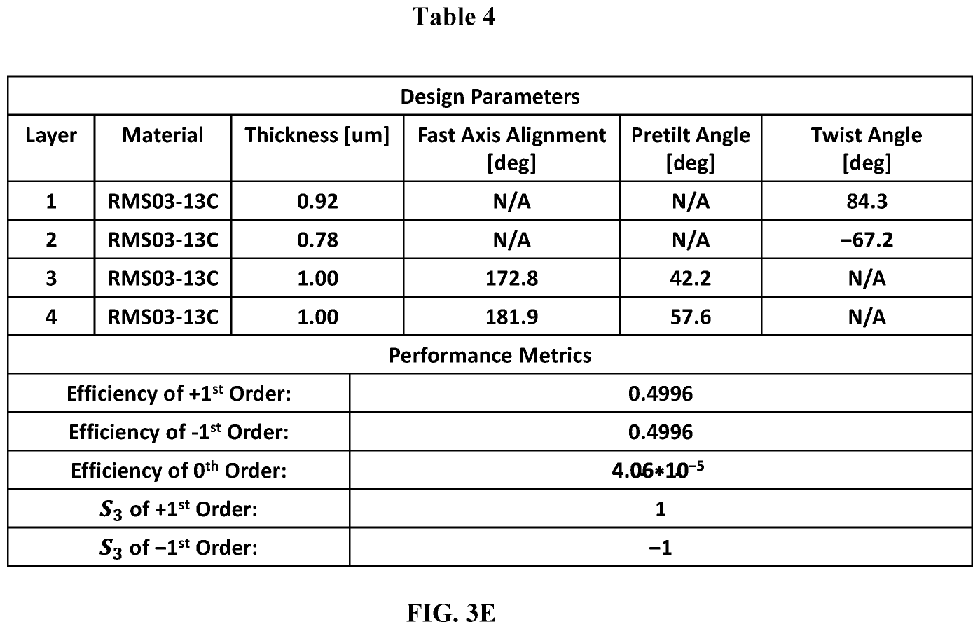

FIG. 3A schematically illustrates a diagram of a PBP device or component 300, according to an embodiment of the present disclosure. The PBP device 300 may include elements that are similar to the PBP device 200 shown in FIG. 2A, the PBP film stack 250 shown in FIG. 2C, or the PBP film stack 270 shown in FIG. 2D. Detailed descriptions of the same or similar elements included in the PBP device 300 may refer to the above description rendered in connection with FIG. 2A, FIG. 2C, or FIG. 2D.

As shown in FIG. 3A, the PBP device 300 may include a PBP film stack 305 and a compensation film stack 310 coupled (e.g., stacked) with the PBP film stack 305. The PBP film stack 305 may have a structure similar to the PBP film stack 250 shown in FIG. 2C. For example, the PBP film stack 305 may include a stack a first PBP film 315-1 and a second PBP film 315-2, which may be similar to the first PBP film 251-1 and the second PBP film 251-2 shown in FIG. 2C, respectively. The compensation film stack 310 may include a stack of a first compensation film 320-1, a second compensation film 320-2, and a third compensation film 320-3. In the embodiment shown in FIG. 3A, each of the first compensation film 320-1, the second compensation film 320-2, and the third compensation film 320-3 may be an A-plate having a fast axis arranged within a film plane of the film. The orientation of an A-plate may be defined by the fast axis alignment, which is the azimuthal angle of the fast axis within the film plane of the film.

In the embodiment shown in FIG. 3A, the PBP device 300 may be designed to have an in-plane pitch of 0.5 μm, and an operation wavelength of 355 nm. In the embodiment shown in FIG. 3A, the PBP film stack 305 is designed for providing a large diffraction angle and a high efficiency for specific orders, e.g., a +1^{st} diffraction order and a −1^{st} diffraction order, via configuring the thicknesses and the twist angles of the PBP films 315-1 and 315-2. The PBP film stack 305 may not control the polarization states of the +1^{st} diffraction order and the −1^{st} diffraction order.

FIG. 3B illustrates a Table 2 showing design parameters and performance metrics of the PBP film stack 305 shown in FIG. 3A, according to an embodiment of the present disclosure. As shown in FIG. 3B, the first PBP film 315-1 (Layer 1 in Table 2) and the second PBP film 315-2 (Layer 2 in Table 2) are designed based on the same LC material RMS03-13C. The thickness and the twist angle of the first PBP film 315-1 (Layer 1 in Table 2) are designed as 0.92 μm and 84.3°, respectively. The thickness and the twist angle of the second PBP film 315-2 (Layer 2 in Table 2) are designed as 0.78 μm and −67.2°, respectively. The combined diffraction efficiency of the PBP film stack 305 for the +1^{st} diffraction order and the −1^{st} diffraction order (i.e., the sum of a first diffraction efficiency for the +1^{st} diffraction order and a second diffraction efficiency for the −1^{st} diffraction order) is greater than 99%, and the diffraction efficiency for the 0^{th} diffraction order is less than 0.5%. As the PBP film stack 305 does not control the polarization states of the +1^{st} diffraction order and the −1^{st} diffraction order, the Stokes parameter S₃ of the +1^{st} diffraction order is 0.98, which is substantially close to 1, whereas the Stokes parameter S₃ of the −1^{st} diffraction order is −0.86, which is much away from −1. That is, the +1^{st} diffraction order is a substantially right-handed circularly polarized beam, and the −1^{st} diffraction order is a left-handed elliptically polarized beam.

Referring back to FIG. 3A, the compensation film stack 310 may be configured to change the polarization states of the +1^{st} diffraction order and the −1^{st} diffraction order output from the PBP film stack 305 to predetermined polarization states, e.g., orthogonal circular polarizations. FIG. 3C illustrates a Table 3 showing design parameters and performance metrics of the PBP device 300 shown in FIG. 3A, according to an embodiment of the present disclosure. The design parameters of the PBP film stack 305 shown in FIG. 3C are the same as those shown in FIG. 3B. The Table 3 in FIG. 3C shows the design parameters of the compensation film stack 310, and performance metrics of the entire PBP device 300.

As shown in FIG. 3C, the first compensation film 320-1 (Layer 3 in Table 3), the second compensation film 320-2 (Layer 4 in Table 3), and the third compensation film 320-3 (Layer 5 in Table 3) are designed based on the same LC material RMS03-13C. The thickness and the fast axis alignment of the first compensation film 320-1 (Layer 3 in Table 3) are designed as 2.08 μm and 116.9°, respectively. The thickness and the fast axis alignment of the second compensation film 320-2 (Layer 4 in Table 3) are designed as 2.93 μm and 90°, respectively. The thickness and the fast axis alignment of the third compensation film 320-3 (Layer 5 in Table 3) are designed as 8.5 μm and 101.6°, respectively.

The combined diffraction efficiency of the PBP device 300 for the +1^{st} diffraction order and the −1^{st} diffraction order (i.e., the sum of a first diffraction efficiency for the +1^{st} diffraction order and a second diffraction efficiency for the −1^{st} diffraction order) is greater than 99%, and the diffraction efficiency for the 0^{th} diffraction order is less than 0.5%. Referring to FIG. 3B and FIG. 3C, the PBP film stack 305 and the PBP device 300 provide substantially the same diffraction efficiency for the +1^{st} diffraction order and the −1^{st} diffraction order (0.4989 in FIG. 3B and 0.4996 in FIG. 3C).

Referring back to FIG. 3C, with the compensation film stack 310, the Stokes parameter S₃ of the +1^{st} diffraction order output from the PBP device 300 is 0.99, which is substantially close to 1, and the Stokes parameter S₃ of the −1^{st} diffraction order output from the PBP device 300 is −0.99, which is substantially close to −1. That is, the +1^{st} diffraction order is a substantially right-handed circularly polarized beam, and the −1^{st} diffraction order is a substantially left-handed circularly polarized beam. Referring to FIG. 3B and FIG. 3C, through configuring the thicknesses and orientations of the compensation films 320-1, 320-2, and 320-3 included in the compensation film stack 310, the compensation film stack 310 may change the polarization states of the +1^{st} diffraction order and the −1^{st} diffraction order output from the PBP film stack 305 to predetermined polarization states, e.g., orthogonal circular polarizations. That is, through configuring the thicknesses and the twist angles of the PBP films 315-1 and 315-2 included in the PBP film stack 305, and the thicknesses and orientations of the compensation films 320-1, 320-2, and 320-3 included in the compensation film stack 310, the PBP device 300 may provide a large diffraction angle, a high efficiency, and a high DoCP output.

FIG. 3D schematically illustrates a diagram of a PBP device or component 350, according to an embodiment of the present disclosure. The PBP device 350 may include elements that are similar to the PBP device 200 shown in FIG. 2A, the PBP film stack 250 shown in FIG. 2C, the PBP film stack 270 shown in FIG. 2D, or the PBP device 300 shown in FIG. 3A. Detailed descriptions of the same or similar elements included in the PBP device 350 may refer to the above description rendered in connection with FIG. 2A, FIG. 2C, FIG. 2D, or FIG. 3A.

As shown in FIG. 3D, the PBP device 350 may include a PBP film stack 355 and a compensation film stack 360 coupled (e.g., stacked) with the PBP film stack 355. The PBP film stack 355 may have a structure similar to the PBP film stack 250 shown in FIG. 2C. For example, the PBP film stack 355 may include a stack a first PBP film 365-1 and a second PBP film 365-2, which may be similar to the first PBP film 251-1 and the second PBP film 251-2 shown in FIG. 2C, respectively. The compensation film stack 360 may include a stack of a first compensation film 370-1 and a second compensation film 370-2. In the embodiment shown in FIG. 3D, each of the first compensation film 370-1 and the second compensation film 370-2 may be an O-plate having a fast axis arranged obliquely to a film plane of the film. The orientation of an O-plate may be defined by the fast axis alignment (that is the azimuthal angle of the fast axis within the film plane of the film), and the pretilt angle of the fast axis with respect to the film plane of the film.

In the embodiment shown in FIG. 3D, the PBP device 350 may be designed to have an in-plane pitch of 0.5 μm, and an operation wavelength of 355 nm. Through configuring the thicknesses and the twist angles of the PBP films 365-1 and 365-2, and the thicknesses and orientations of the compensation films 370-1 and 370-2, the PBP device 350 may provide a large diffraction angle, a high efficiency, and a high DoCP output.

FIG. 3E illustrates a Table 4 showing design parameters and performance metrics of the PBP device 350 shown in FIG. 3D, according to an embodiment of the present disclosure. As shown in FIG. 3E, the first PBP film 365-1 (Layer 1 in Table 4), the second PBP film 365-2 (Layer 2 in Table 4), the first compensation film 370-1 (Layer 3 in Table 4), and the second compensation film 370-2 (Layer 4 in Table 4) are designed based on the same LC material RMS03-13C. The thickness and the twist angle of the first PBP film 365-1 (Layer 1 in Table 4) are designed as 0.92 μm and 84.3°, respectively. The thickness and the twist angle of the second PBP film 365-2 (Layer 2 in Table 4) are designed as 0.78 μm and −67.2°, respectively.

The thickness, the fast axis alignment, and the pretilt angle of the first compensation film 370-1 (Layer 3 in Table 4) are designed as 1 μm, 172.8°, and 42.2°, respectively. The thickness, the fast axis alignment, and the pretilt angle of the second compensation film 370-2 (Layer 4 in Table 4) are designed as 1 μm, 181.9°, and 57.6°, respectively.

The combined diffraction efficiency of the PBP device 350 for the +1^{st} diffraction order and the −1^{st} diffraction order (i.e., the sum of a first diffraction efficiency for the +1^{st} diffraction order and a second diffraction efficiency for the −1^{st} diffraction order) is greater than 99%, and the diffraction efficiency for the 0^{th} diffraction order is less than 0.5%. The Stokes parameter S₃ of the +1^{st} diffraction order is 1, and the Stokes parameter S₃ of the −1^{st} diffraction order is −1. That is, the +1^{st} diffraction order is a right-handed circularly polarized beam, and the −1^{st} diffraction order is a left-handed circularly polarized beam.

Referring to FIGS. 3C and 3E, the PBP film stack 305 shown in FIG. 3A and the PBP film stack 355 shown in FIG. 3D may have the same design parameters, whereas the compensation film stack 310 shown in FIG. 3A and the compensation film stack 360 shown in FIG. 3D may have different configurations and different design parameters. That is, different compensation film stacks may be used for changing or correcting the polarization states of the +1^{st} diffraction order and the −1^{st} diffraction order output from the PBP film stack 305 or 355 to predetermined polarization states.

The compensation film stack 310 shown in FIG. 3A and the compensation film stack 360 shown in FIG. 3D are for illustrative purposes, a compensation film stack may be configured with another suitable configuration and other suitable design parameters for changing or correcting the polarization states of the +1^{st} diffraction order and the −1^{st} diffraction order output from the PBP film stack 305 or 355 to predetermined polarization states, e.g., orthogonal circular polarizations. For example, an O-plate may be replaced by a combination of a tilted A-plane and a C-plate, and a compensation film stack may include two tilted A-plates and two C-plates. The PBP film stack 305 shown in FIG. 3A and the PBP film stack 355 shown in FIG. 3D are for illustrative purposes. A PBP film stack may be configured with another suitable configuration and other suitable design parameters for providing a large diffraction angle and a high efficiency for the +1^{st} diffraction order and the −1^{st} diffraction order.

The disclosed PBP devices with a large diffraction angle, a high efficiency, and a high degree of circular polarization output may be implemented in systems or devices for imaging, sensing, communication, biomedical applications, etc. For example, the disclosed PBP devices may be implemented in various systems for augmented reality (“AR”), virtual reality (“VR”), and/or mixed reality (“MR”) applications, e.g., near-eye displays (“NEDs”), head-up displays (“HUDs”), head-mounted displays (“HMDs”), smart phones, laptops, televisions, vehicles, etc. The disclosed PBP devices may also be used as a mask for proximity duplication of liquid crystal polarization holograms (“LCPHs”). In this process, the PBP device may be illuminated with a linearly polarized beam with spatially uniform linear polarization. The mask may diffract a linearly polarized beam as a right-handed circularly polarized beam and a left-handed circularly polarized beam. The right-handed circularly polarized beam and the left-handed circularly polarized beam may interfere with one another within a beam interference zone (which is a spatial zone) to generate a superimposed wave that has a substantially uniform intensity and a varying linear polarization. A pattern of the spatial variations of linear polarization within the beam interference zone (referred to as a polarization interference pattern) may be recorded in a polarization sensitive recording medium disposed within the beam interference zone. Large diffraction angles of the right-handed circularly polarized beam and the left-handed circularly polarized beam may lead to more tightly spaced spatial variations of linear polarization. A high degree of linear polarization in the polarization interference pattern may be highly desirable for efficiently patterning the polarization sensitive recording medium.

Liquid crystal polarization holograms (“LCPHs”) refer to the intersection of liquid crystal devices and polarization holograms. LCPHs have features such as small thickness, light weight, compactness, large aperture, high efficiency, simple fabrication, etc. Thus, LCPHs have gained increasing interests in optical device and system applications, e.g., near-eye displays (“NEDs”), head-up displays (“HUDs”), head-mounted displays (“HMDs”), smart phones, laptops, televisions, or vehicles, etc. For example, LCPHs may be used for addressing accommodation-vergence conflict, enabling thin and highly efficient eye-tracking and depth sensing in space constrained optical systems, developing optical combiners for image formation, correcting chromatic aberrations for image resolution enhancement of refractive optical elements in compact optical systems, and improving the efficiency and reducing the size of optical systems.

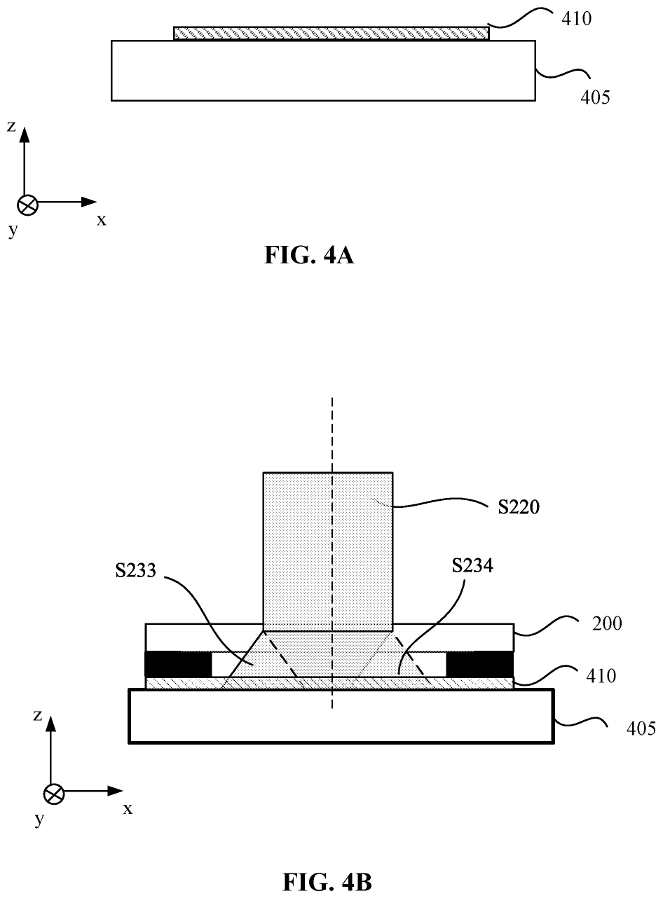

FIGS. 4A-4D schematically illustrate processes for fabricating an LCPH element 400 using a disclosed PBP device as a mask, according to an embodiment of the present disclosure. For discussion purposes, the PBP device 200 shown in FIG. 2A is used as the mask in the fabrication processes shown in FIGS. 4A-4D. The PBP device 200 used as the mask for fabricating the LCPH element 400 may also be referred to as a PBP mask 200. The PBP mask 200 may have the in-plane pitch at the level of one micron or less. The PBP mask 200 may deflect the input beam S220 as two signal beams S233 and S234 with a large diffraction angle, a high efficiency, and a high degree of circular polarization.

The fabrication process shown in FIGS. 4A-4D may include holographic recording of an alignment pattern in a photo-aligning film and alignment of an anisotropic material (e.g., an LC material) by the photo-aligning film. This alignment process may be referred to as a surface-mediated photo-alignment. In some embodiments, the LCPH element 400 fabricated based on the fabrication processes shown in FIGS. 4A-4D may be a PVH element or a PBP element (e.g., PVH/PBP grating, PVH/PBP lens, etc.). For illustrative purposes, the substrate and different layers, films, or structures formed thereon are shown as having flat surfaces. In some embodiments, the substrate and different layers or films or structures may have curved surfaces.

As shown in FIG. 4A, a recording medium layer 410 may be formed on a surface (e.g., a top surface) of a substrate 405 by dispensing a polarization sensitive material on the surface of the substrate 405. Thus, the recording medium layer 410 may be referred to as a polarization sensitive recording medium layer. The polarization sensitive material included in the recording medium layer 410 may be an optically recordable and polarization sensitive material (e.g., a photo-alignment material) configured to have a photo-induced optical anisotropy when exposed to a polarized light irradiation. Molecules (or fragments) and/or photo-products of the optically recordable and polarization sensitive material may be configured to generate an orientational ordering under a polarized light irradiation.

After the recording medium layer 410 is formed on the substrate 405, as shown in FIG. 4B, the recording medium layer 410 may be exposed to a polarization interference pattern generated by the two signal beams S233 and S234 (also referred to as a first recording beam S233 and a second recording beam S234) output from the PBP mask 200. The two recording beams S233 and S234 (and the input beam S220) may be two coherent circularly polarized beams with opposite handednesses. The two recording beams S233 and S234 may have a wavelength within an absorption band of the recording medium layer 410, e.g., ultraviolet (“UV”), violet, blue, or green beams. In some embodiments, the two recording beams S233 and S234 may be laser beams, e.g., UV, violet, blue, or green laser beams.

The recording beams S233 and S234 may interference with one another to generate the polarization interference pattern in a spatial region, in which the recording medium layer 410 may be disposed. The superposition of the two recording beams S233 and S234 may result in a superimposed wave that has a substantially uniform intensity and a varying linear polarization. For example, the linear polarization direction of the superimposed wave may spatially vary within the spatial region in which the two circularly polarized beams interfere with one another. In other words, the superimposed wave may have a linear polarization with an orientation (or a polarization direction) that is spatially varying within the spatial region in which the two circularly polarized beams interfere with one another. The polarization interference pattern may also be a pattern of the spatially varying orientation (or polarization direction) of the linear polarization of the superimposed wave, or a pattern of the varying linear polarization of the superimposed wave.

In some embodiments, the orientation of the linear polarization may periodically vary within the spatial region. A pattern of the periodic, spatial variation of the orientation of the linear polarization that is recorded in the recording medium layer may define a grating pattern. A period of the grating pattern (or an in-plane pitch of the pattern of the spatially varying orientation of the linear polarization) may be determined by the diffraction angles of the recording beams S233 and S234, and the wavelength of the recording beams S233 and S234. When the wavelength of the recording beams S233 and S234 is fixed, the period of the grating pattern may decrease as the diffraction angles of the recording beams S233 and S234 increase.

The recording medium layer 410 may be optically patterned when exposed to the polarization interference pattern generated based on the two recording beams S233 and S234 during the polarization interference exposure process. An orientation pattern of an optic axis of the recording medium layer 410 in an exposed region may be defined by the polarization interference pattern under which the recording medium layer 410 is exposed during the polarization interference exposure process. In some embodiments, the recording medium layer 410 may include elongated anisotropic photo-sensitive units (e.g., small molecules or fragments of polymeric molecules). After being subjected to a sufficient exposure of the polarization interference pattern generated based on the two recording beams S233 and S234, local alignment directions of the anisotropic photo-sensitive units may be induced in the recording medium layer 410 by the polarization interference pattern, resulting in an alignment pattern (or in-plane modulation) of an optic axis of the recording medium layer 410 due to a photo-alignment of the anisotropic photo-sensitive units. After the recording medium layer 410 is optically patterned, the recording medium layer 410 may be referred to as a patterned recording medium layer with an alignment pattern.

In some embodiments, as shown in FIG. 4C, a birefringent medium layer 415 may be formed on the patterned recording medium layer 410 by dispensing, e.g., coating or depositing, a birefringent medium onto the patterned recording medium layer 410. The birefringent medium may include one or more birefringent materials having an intrinsic birefringence, such as non-polymerizable LCs or polymerizable LCs (e.g., reactive mesogens or RMs). For discussion purposes, in the following descriptions, the term “liquid crystal(s)” or “LC(s)” may encompass both mesogenic and LC materials. In some embodiments, the birefringent medium may also include or be mixed with other ingredients, such as solvents, initiators (e.g., photo-initiators or thermal initiators), chiral dopants, or surfactants, etc. In some embodiments, the birefringent medium may not have an intrinsic or induced chirality. In some embodiments, the birefringent medium may have an intrinsic or induced chirality. For example, in some embodiments, the birefringent medium may include a host birefringent material and a chiral dopant doped into the host birefringent material at a predetermined concentration. The chirality may be introduced by the chiral dopant doped into the host birefringent material, e.g., chiral dopant doped into nematic LCs, or chiral reactive mesogens (“RMs”) doped into achiral RMs. RMs may be also referred to as a polymerizable mesogenic or liquid-crystalline compound, or polymerizable LCs. In some embodiments, the birefringent medium may include a birefringent material having an intrinsic molecular chirality, and chiral dopants may not be doped into the birefringent material. The chirality of the birefringent medium may result from the intrinsic molecular chirality of the birefringent material. For example, the birefringent material may include chiral liquid crystal molecules, or molecules having one or more chiral functional groups. In some embodiments, the birefringent material may include twist-bend nematic LCs (or LCs in twist-bend nematic phase), in which LC directors may exhibit periodic twist and bend deformations forming a conical helix with doubly degenerate domains having opposite handednesses. The LC directors of twist-bend nematic LCs may be tilted with respect to the helical axis. Thus, the twist-bend nematic phase may be considered as the generalized case of the conventional nematic phase in which the LC directors are perpendicular to the helical axis.

In some embodiments, a birefringent medium may be dissolved in a solvent to form a solution. A suitable amount of the solution may be dispensed (e.g., coated, or sprayed, etc.) on the patterned recording medium layer 410 to form the birefringent medium layer 415. In some embodiments, the solution containing the birefringent medium may be coated on the patterned recording medium layer 410 using a suitable process. In some embodiments, the birefringent medium may be heated to remove the remaining solvent. This process may be referred to as a pre-exposure heating. The patterned recording medium layer 410 may be configured to provide a surface alignment (e.g., planar alignment, or homeotropic alignment, etc.) to optically anisotropic molecules (e.g., LC molecules, RM molecules, etc.) in the birefringent medium. For example, the patterned recording medium layer 410 may at least partially align the LC molecules or RM molecules in the birefringent medium that are in contact with the patterned recording medium layer 410 in the grating pattern. In other words, the LC molecules or RM molecules in the birefringent medium may be at least partially aligned along the local alignment directions of the anisotropic photo-sensitive units in the patterned recording medium layer 410 to form the grating pattern. Thus, the grating pattern recorded in the patterned recording medium layer 410 (or the in-plane orientation pattern of the optic axis of the recording medium layer 410) may be transferred to the birefringent medium, and hence to the birefringent medium layer 415. That is, the patterned recording medium layer 410 may function as a photo-alignment material (“PAM”) layer for the LCs or RMs in the birefringent medium. Such an alignment procedure may be referred to as a surface-mediated photo-alignment.

In some embodiments, after the LCs or RMs in the birefringent medium are aligned by the patterned recording medium layer 410, the birefringent medium may be heat treated (e.g., annealed) in a temperature range corresponding to a nematic phase of the LCs or RMs in birefringent medium to enhance the alignments (or orientation pattern) of the LCs and/or RMs (not shown in FIG. 4C). This process may be referred to as a post-exposure heat treatment (e.g., annealing). In some embodiments, the process of heat treating (e.g., annealing) the birefringent medium may be omitted.

In some embodiments, when the birefringent medium includes polymerizable LCs (e.g., RMs), after the RMs are aligned by the patterned recording medium layer 410, the RMs may be polymerized, e.g., thermally polymerized or photo-polymerized, to solidify and stabilize the orientational pattern of the optic axis of the birefringent medium, thereby forming the birefringent medium layer 415. In some embodiments, as shown in FIG. 4D, the birefringent medium may be irradiated with, e.g., a UV light 444. Under a sufficient UV light irradiation, the birefringent medium may be polymerized to stabilize the orientational pattern of the optic axis of the birefringent medium. In some embodiments, the polymerization of the birefringent medium under the UV light irradiation may be carried out in air, in an inert atmosphere formed, for example, by nitrogen, argon, carbon-dioxide, or in vacuum. Thus, a polarization selective grating 400 may be obtained based on the polarization interference exposure process and surface-mediated photo-alignment. In some embodiments, the process of thermo- or photo-polymerization of the birefringent medium may be omitted. In some embodiments, the polarization selective grating 400 fabricated based on the fabrication processes shown in FIGS. 4A-4D may be a passive polarization selective grating, such as a passive PBP grating or a passive PVH grating.

As the PBP mask 200 deflects the input beam S220 as two recording beams S233 and S234 with large diffraction angles, the polarization interference pattern generated by the recording beams S233 and S234 may have a fine in-plane pitch (e.g., 200 nm to 800 nm). Accordingly, the polarization selective grating 400 fabricated using the PBP mask 200 may have a fine in-plane pitch (e.g., 200 nm to 800 nm). In addition, as the PBP mask 200 deflects the input beam S220 as two recording beams S233 and S234 with a high efficiency and a high degree of circular polarization, the optical patterning process of the recording medium layer 410 may be enhanced. Accordingly, the quality of the fabricated polarization selective grating 400 may be enhanced.

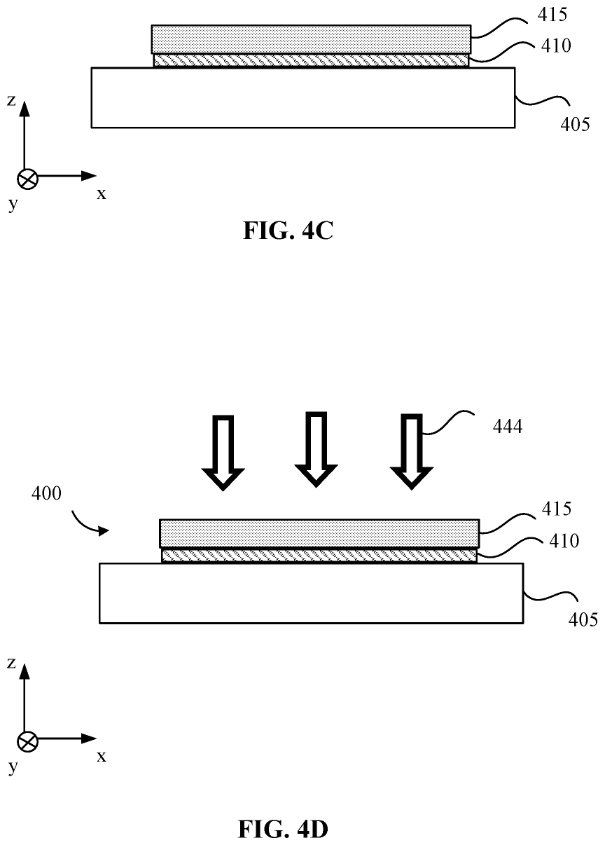

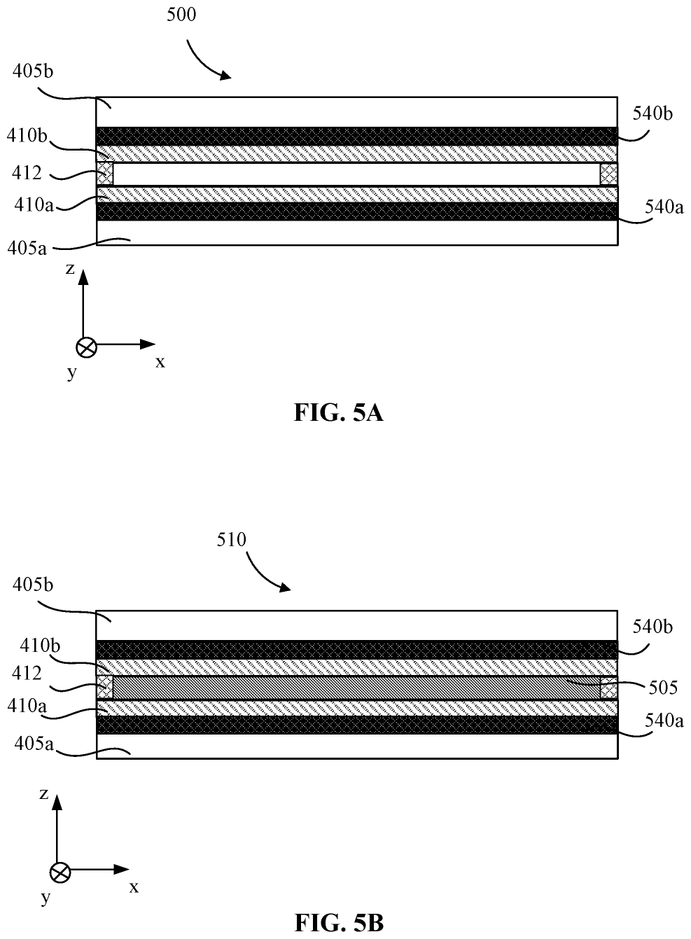

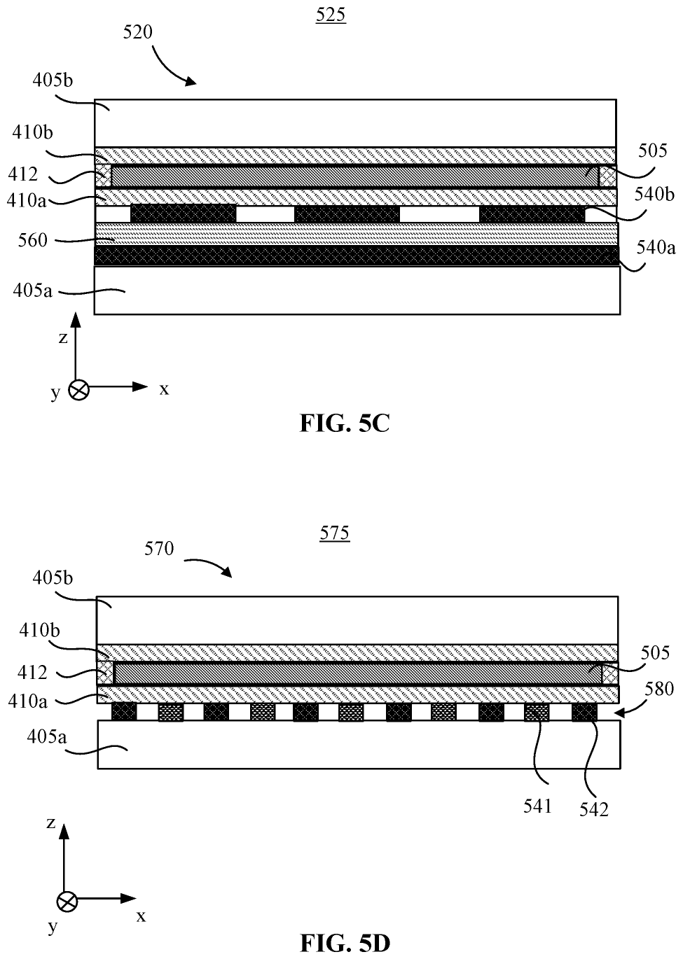

FIGS. 5A and 5B schematically illustrate processes for fabricating an LCPH element 400 using a disclosed PBP device as a mask (e.g., the PBP mask 200 shown in FIG. 2A), according to an embodiment of the present disclosure. The fabrication processes shown in FIGS. 5A and 5B may include steps or processes similar to those shown in FIGS. 4A-4D. The LCPH element fabricated based on the processes shown in FIGS. 5A and 5B may include elements similar to those included in the LCPH element fabricated based on the processes shown in FIGS. 4A-4D. Descriptions of the similar steps and similar elements can refer to the descriptions rendered above in connection with FIGS. 4A-4D. The LCPH element fabricated based on the fabrication processes shown in FIGS. 5A and 5B may be an active LCPH element, such as an active PBP grating or an active PVH grating, etc. Although the substrate and layers are shown as having flat surfaces, in some embodiments, the substrate and layers formed thereon may have curved surfaces.

As shown in FIG. 5A, two substrates 405a and 405b (referred to as a first substrate 405a and a second substrate 405b) may be assembled to form an LC cell 500. For example, the two substrates 405a and 405b may be bonded to each other via an adhesive 412 (e.g., optical adhesive 412) to form the LC cell 500. At least one (e.g., each) of the two substrates 405a and 405b may be provided with one or more conductive electrode layers and a patterned recording medium layer. For example, two conductive electrode layers 540a and 540b may be formed at opposing inner surfaces of the substrates 405a and 405b, and two patterned recording medium layer 410a and 410b may be formed on opposing inner surfaces of the two conductive electrode layers 540a and 540b. The patterned recording medium layers 410a and 410b may be fabricated at the opposing inner surfaces of the conductive electrode layers 540a and 540b following steps or processes similar to those shown in FIGS. 4A and 4B. The conductive electrode layer 540a or 540b may be a planar continuous electrode layer or a patterned electrode layer. As shown in FIG. 5A, a gap or space may exist between the patterned recording medium layers 410a and 410b.

After the LC cell 500 is assembled, as shown in FIG. 5B, active LCs that are reorientable by an external field, e.g., an electric field, may be filled into the space formed between the patterned recording medium layers 410a and 410b within the LC cell 500 to form an active LC layer 505. The patterned recording medium layer 410a or 410b may function as a PAM layer for the active LCs filled into the LC cell 500, such that the active LCs may be at least partially aligned by the patterned recording medium layer 410a or 410b according to a grating pattern to form the active LC layer 505. Thus, the patterned recording medium layer 410 or 410′ may also be referred to as PAM layers 410a and 410b. The LC cell 500 filled with the active LCs may be sealed via, e.g., the adhesive 412, and an active LCPH element (e.g., active PBP or PVH grating) 510 may be obtained. The active LCPH element 510 may be switchable to change its optical properties by a voltage applied to the conductive electrode layers 540a and 540b.

For illustrative purposes, FIGS. 5A and 5B show that the patterned recording medium layers 410a and 410b (or PAM layers 410a and 410b) may be disposed at opposing inner surfaces of the two substrates 405a and 405b. In some embodiments, each of the PAM layers 410a and 410b disposed at the two substrates 405a and 405b may be configured to provide a planar alignment (or an alignment with a small pretilt angle). The PAM layers 410a and 410b may provide parallel or anti-parallel surface alignments. In some embodiments, the PAM layers 410a and 410b disposed at the two substrates 405a and 405b may be configured to provide hybrid surface alignments. For example, the PAM layer 410a disposed at the substrate 405a may be configured to provide a planar alignment (or an alignment with a small pretilt angle), and the PAM layer 410b disposed at the other substrate 405b may be configured to provide a homeotropic alignment. Although not shown, in some embodiments, only one of the substrates 405a and 405b may be provided with the PAM layer 410a or 410b.

For illustrative purposes, FIGS. 5A and 5B show that conductive electrode layers 540a and 540b may be disposed at the two substrates 405a and 405b. The conductive electrode layer (540a or 540b) may be disposed between the patterned recording medium layer (410a or 410b) and the substrate (405a or 405b). In the embodiment shown in FIGS. 5A and 5B, each of the conductive electrode layers 540a and 540b may be a continuous planar electrode layer. A driving voltage may be applied to the conductive electrode layers 540a and 540b to generate a vertical electric field to reorient the LC molecules, thereby switching the optical properties of the active LCPH element (e.g., active PBP or PVH grating) 510. As shown in FIG. 5B, the conductive electrode layers 540a and 540b may be disposed at two sides of the active LC layer 505.

In some embodiments, the two conductive electrode layers 540a and 540b may be disposed at the same side of the active LC layer 505. For example, as shown in FIG. 5C, two substrates 405a and 405b may be assembled to form an LC cell 520. One substrate 405b (e.g., an upper substrate) may not be provided with a conductive electrode layer, whereas the other substrate 405a (e.g., a lower substrate) may be provided with two conductive electrode layers (e.g., 540a and 540b) and an electrically insulating layer 560 disposed between the two conductive electrode layers. In other words, the two conductive electrode layers 540a and 540b may be disposed at the same side of the active LC layer 505. The two conductive electrode layers 540a and 540b may be a continuous planar electrode layer 540a and a patterned electrode layer 540b. The patterned electrode layer 540b may include a plurality of striped electrodes arranged in parallel in an interleaved manner. After the LC cell 520 is filled with active LCs to form the active LC layer 505, an active LCPH element (e.g., active PBP or PVH grating) 525 may be obtained. A voltage may be applied between the continuous planar electrode layer 540a and the patterned electrode layer 540b disposed at the same side of the active LC layer 505 to generate a horizontal electric field to reorient the LC molecules, thereby switching the optical properties of the fabricated active LCPH element 525.

In some embodiments, as shown in FIG. 5D, two substrates 405a and 405b may be assembled to form an LC cell 570. One substrate 405b (e.g., an upper substrate) may not be provided with a conductive electrode layer, whereas the other substrate 405a (e.g., a lower substrate) may be provided with a conductive electrode layer 580. The conductive electrode layer 580 may include interdigitated electrodes, which may include two individually addressable interdigitated comb-like electrode structures 541 and 542. After the LC cell 560 is filled with active LCs to form the active LC layer 505, an active LCPH element (e.g., active PBP or PVH grating) 575 may be obtained. A voltage may be applied between the interdigitated comb-like electrode structures 541 and 542 disposed at the same side of the active LC layer 505 to generate a horizontal electric field to reorient the LC molecules in the active LC layer 505, thereby switching the optical properties of the fabricated active LCPH element 575.

Referring back to FIGS. 5A-5D, in some embodiments, the recording medium layer(s) may not be optically patterned before the LC cell is assembled. Instead, the recording medium layer(s) may be optically patterned after the LC cell is assembled. For example, two substrates 405a and 405b may be assembled to form an LC cell. At least one of the two substrates 405a and 405b may be provided with one or more conductive electrode layers and a recording medium layer (that has not been optically patterned yet). Then the LC cell may be exposed to a polarization interference pattern, which may be similar to that shown in FIG. 4B. Accordingly, the recording medium layer disposed at the substrate may be optically patterned to provide an alignment pattern corresponding to a grating pattern. After the LC cell is filled with active LCs and sealed, an active LCPH element (e.g., active PBP or PVH grating) may be obtained.

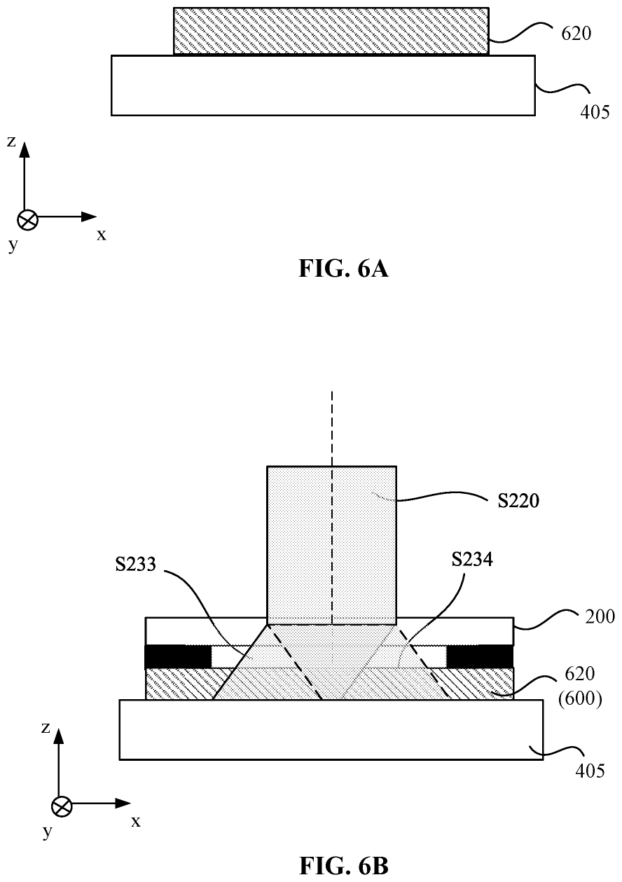

FIGS. 6A and 6B schematically illustrate processes for fabricating an LCPH element 600 using a disclosed PBP device as a mask (e.g., the PBP mask 200 shown in FIG. 2A), according to an embodiment of the present disclosure. The fabrication processes may include holographic recording and bulk-mediated photo-alignment. The fabrication processes shown in FIGS. 6A and 6B may include steps similar to those shown in FIGS. 4A and 4B. The LCPH element 600 fabricated based on the processes shown in FIGS. 6A and 6B may include elements similar to the LCPH element 400 fabricated based on the processes shown in FIGS. 4A and 4B. Descriptions of the similar steps and similar elements, structures, or functions can refer to the descriptions rendered above in connection with FIGS. 4A and 4B. The LCPH element 600 fabricated based on the fabrication processes shown in FIGS. 6A and 6B may be a passive LCPH element.

Similar to the embodiment shown in FIGS. 4A and 4B, the processes shown in FIGS. 6A and 6B may include dispensing a recording medium on a surface (e.g., a top surface) of the substrate 405 to form a recording medium layer 620. The recording medium may include an optically recordable and polarization sensitive material (e.g., a photo-alignment material) configured to have a photo-induced optical anisotropy when exposed to the polarized light irradiation. Molecules (or fragments) and/or photo-products of the optically recordable and polarization sensitive material may generate anisotropic angular distributions in a film plane of a layer of the recording medium under a polarized light irradiation. After the recording medium layer 620 is formed on the substrate 405, as shown in FIG. 6B, the recording medium layer 620 may be exposed to a polarization interference pattern generated based on two recording beams S233 and S234 output from the PBP mask 200, and hence may be optically patterned. An orientation pattern of an optic axis of the recording medium layer 620 in an exposed region may be defined during the polarization interference exposure process.

In the embodiment shown in FIGS. 6A and 6B, the recording medium may include a photo-sensitive polymer. Molecules of the photo-sensitive polymer may include one or more polarization sensitive photo-reactive groups embedded in a main polymer chain or a side polymer chain. During the polarization interference exposure process of the recording medium layer 620, a photo-alignment of the polarization sensitive photo-reactive groups may occur within (or in, inside) a volume of the recording medium layer 620. That is, a 3D polarization field generated by the interface of the two recording beams S233 and S234 may be directly recorded within (or in, inside) the volume of the recording medium layer 620. Such an alignment procedure shown in FIG. 6B may be referred to as a bulk-mediated photo-alignment. The recording medium layer 620 for a bulk-mediated photo-alignment shown in FIG. 6B may be relatively thicker than the recording medium layer 410 for a surface-mediated photo-alignment shown in FIGS. 4B-4D. A step of disposing an additional birefringent medium layer on the patterned recording medium layer 620 may be omitted. The patterned recording medium layer 620 may function as a polarization selective grating 600, e.g., a PBP grating or PVH grating.

As the PBP mask 200 deflects the input beam S220 as two recording beams S233 and S234 with large diffraction angles, the 3D polarization interference pattern generated by the recording beams S233 and S234 may have a fine in-plane pitch (e.g., 200 nm to 800 nm). Accordingly, the polarization selective grating 600 fabricated using the PBP mask 200 may have a fine in-plane pitch (e.g., 200 nm to 800 nm). In addition, as the PBP mask 200 deflects the input beam S220 as two recording beams S233 and S234 with a high efficiency and a high degree of circular polarization, the optical patterning process of the recording medium layer 620 may be enhanced. Accordingly, the quality of the fabricated polarization selective grating 600 may be enhanced.

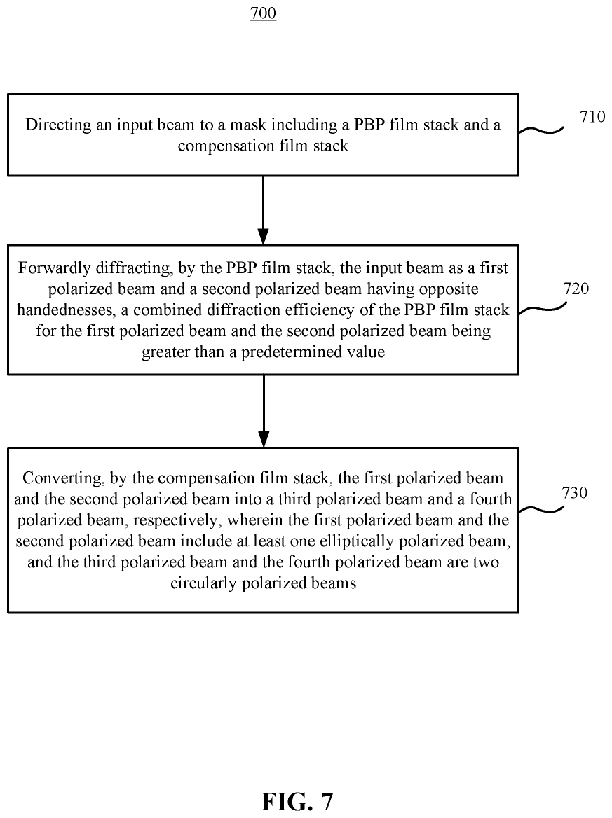

FIG. 7 illustrates a flowchart showing a method 700 for fabricating an LCPH element (e.g., a PBP or PVH grating or lens), according to an embodiment of the present disclosure. As shown in FIG. 7, the method may include directing an input beam to a mask including a PBP film stack and a compensation film stack (Step 710). The method 700 may also include forwardly diffracting, by the PBP film stack, the input beam as a first polarized beam and a second polarized beam having opposite handednesses, a combined diffraction efficiency of the PBP film stack for the first polarized beam and the second polarized beam being greater than a predetermined value (Step 720).

The method 700 may also include converting, by the compensation film stack, the first polarized beam and the second polarized beam into a third polarized beam and a fourth polarized beam, respectively (Step 730). In some embodiments, the first polarized beam and the second polarized beam include at least one elliptically polarized beam, and the third polarized beam and the fourth polarized beam are two circularly polarized beams. In some embodiments, converting, by the compensation film stack, the first polarized beam and the second polarized beam into the third polarized beam and the fourth polarized beam, respectively, may include converting, by the compensation film stack, the at least one elliptically polarized beam into at least one of the two circularly polarized beams.

In some embodiments, the PBP film stack may include a plurality of PBP films, each of which being configured with an in-plane pitch that is equal to or less than 1 μm. In some embodiments, the predetermined value may be 99%. In some embodiments, the compensation film stack may include at least one of a uniaxial plate or a biaxial plate. In some embodiments, the uniaxial plate may include an A-plate, a C-plate, or an oblique compensation plate (“O-plate”). In some embodiments, the compensation film stack may include three A-plates or two O-plates. In some embodiments, the method may further include generating a polarization interference pattern in a spatial zone by the third polarized beam and the fourth polarized beam interfering with one another. In some embodiments, the method 700 may further include exposing a polarization sensitive recording medium disposed in the spatial zone to the polarization interference pattern. In some embodiments, the method 700 may further include forming an optically anisotropic film on the polarization sensitive recording medium that has been exposed to the polarization interference pattern.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a Pancharatnam-Berry phase (“PBP”) film stack configured to diffract an input beam as a first polarized beam and a second polarized beam having opposite handednesses, a combined diffraction efficiency of the PBP film stack for the first polarized beam and the second polarized beam being greater than a predetermined value; and
a compensation film stack coupled with the PBP film stack, and configured to respectively convert the first polarized beam and the second polarized beam into a third polarized beam and a fourth polarized beam having the opposite handednesses,
wherein the first polarized beam and the second polarized beam include at least one elliptically polarized beam, and the third polarized beam and the fourth polarized beam are two circularly polarized beams, and
wherein the compensation film stack is configured to convert the at least one elliptically polarized beam into at least one of the two circularly polarized beams.

2. The device of claim 1, wherein an absolute value of a Stokes parameter S₃ of the third polarized beam is greater than an absolute value of the Stokes parameter S₃ of the first polarized beam, and an absolute value of the Stokes parameter S₃ of the fourth polarized beam is greater than an absolute value of the Stokes parameter S₃ of the third polarized beam.

3. The device of claim 1, wherein the PBP film stack includes a plurality of PBP films, each of which being configured to operate in a non-paraxial domain for a predetermined operation wavelength range of the device.

4. The device of claim 3, wherein the plurality of PBP films include a first PBP film configured with a positive twist angle and a second PBP film configured with a negative twist angle.

5. The device of claim 1, wherein the predetermined value is 99%.

6. The device of claim 1, wherein the compensation film stack includes at least one of a uniaxial plate or a biaxial plate.

7. The device of claim 6, wherein the uniaxial plate includes an A-plate, a C-plate, or an oblique compensation plate (“O-plate”).

8. The device of claim 1, wherein the compensation film stack includes three A-plates, or two O-plates.

9. The device of claim 1, wherein the first polarized beam and the second polarized beam include a +1^{st} order diffracted beam and a −1^{st} order diffracted beam having the opposite handednesses.

10. The device of claim 1, wherein the third polarized beam and the fourth polarized beam are configured to interfere with one another to generate a polarization interference pattern in a spatial zone.

11. The device of claim 10, wherein the polarization interference pattern is recordable into a polarization sensitive recording medium.

12. A method, comprising:
directing an input beam to a mask including a PBP film stack and a compensation film stack;
forwardly diffracting, by the PBP film stack, the input beam as a first polarized beam and a second polarized beam having opposite handednesses, a combined diffraction efficiency of the PBP film stack for the first polarized beam and the second polarized beam being greater than a predetermined value; and
converting, by the compensation film stack, the first polarized beam and the second polarized beam into a third polarized beam and a fourth polarized beam, respectively,
wherein the first polarized beam and the second polarized beam include at least one elliptically polarized beam, and the third polarized beam and the fourth polarized beam are two circularly polarized beams, and
wherein converting, by the compensation film stack, the first polarized beam and the second polarized beam into the third polarized beam and the fourth polarized beam, respectively, includes converting, by the compensation film stack, the at least one elliptically polarized beam into at least one of the two circularly polarized beams.

13. The method of claim 12, wherein the PBP film stack includes a plurality of PBP films, each of which being configured to operate in a non-paraxial domain for a predetermined operation wavelength range of the device.

14. The method of claim 12, wherein the predetermined value is 99%.

15. The method of claim 12, wherein the compensation film stack includes at least one of a uniaxial plate or a biaxial plate.

16. The method of claim 15, wherein the uniaxial plate includes an A-plate, a C-plate, or an oblique compensation plate (“O-plate”).

17. The method of claim 12, wherein the compensation film stack includes three A-plates or two O-plates.

18. The method of claim 12, further comprising generating a polarization interference pattern in a spatial zone by the third polarized beam and the fourth polarized beam interfering with one another.

19. The method of claim 18, further comprising exposing a polarization sensitive recording medium disposed in the spatial zone to the polarization interference pattern to record the polarization interference pattern in the polarization sensitive recording medium.

20. The method of claim 19, further comprising forming an optically anisotropic film on the polarization sensitive recording medium that has been exposed to the polarization interference pattern.
